(19) United States
(12) Patent Application Publication
(10) Pub. No.: US 2025/0066106 A1
(43) Pub. Date: Feb. 27, 2025

(54) SYSTEMS AND METHODS FOR A DISPENSING SYSTEM

(71) Applicant: PillNurse, Inc., Glendale, AZ (US)

(72) Inventor: Troy G. Anderson, Scottsdale, AZ (US)

(21) Appl. No.: 18/812,703

(22) Filed: Aug. 22, 2024

Related U.S. Application Data
(60) Provisional application No. 63/534,724, filed on Aug. 25, 2023.
(60) Provisional application No. 63/656,251, filed on Jun. 5, 2024.

(51) Int. Cl. B65D 83/04

(52) U.S. Cl. CPC B65D 83/0409; B65D 83/0454; B65D 2583/0481

(57) ABSTRACT

A dispensing system that includes a dispenser arrangement that has a plurality of dividers. Each divider of the plurality of dividers includes a base, an array of partitions, a first stop member, a second stop member, and an opening. The base has a first base surface opposite a second base surface. The array of partitions extends from the second base surface. Each partition of the array of partitions defines a leading partition surface and a following partition surface. The second stop member of one divider of the plurality of dividers is configured to engage the first stop member of another divider of the plurality of dividers to prevent relative movement between the dividers. The opening is formed in the base and extends through each of the first and second base surfaces.

### CROSS-REFERENCE TO RELATED APPLICATIONS

This application claims the benefit and priority to, and incorporates herein by reference in their entirety U.S. Provisional Application No. 63/534,724, filed on Aug. 25, 2023, and U.S. Provisional Application No. 63/656,251, filed on Jun. 5, 2024.

### BACKGROUND

This disclosure is directed toward systems and methods for dispensing items, and more particularly, dispensing items controllably. Systems and methods described herein can be used for dispensing a variety of consumables or materials that may require or otherwise benefit from controlled released, regulated or restricted access, tamper-resistant storage, or combinations thereof.

For example, it can be generally useful to regulate the distribution of medication, including pills, such as tablets and capsules. Such regulation can be helpful to control dosage, prevent tampering, or provide reminders.

### SUMMARY

According to a first aspect, the present disclosure provides a dispensing system. The dispensing system can be used for medication, including pills or other dispensable items. The dispensing system includes a dispenser arrangement. The dispenser arrangement includes a plurality of dividers. Each divider of the plurality of dividers includes a base that has a first base surface opposite a second base surface, an array of partitions, first and second stop members, and an opening formed in the base and extending through each of the first and second base surfaces. The array of partitions extends from the second base surface. Each partition of the array of partitions defines a leading partition surface and a following partition surface. The second stop member of one divider of the plurality of dividers is configured to engage the first stop member of another divider of the plurality of dividers to prevent relative movement between the dividers.

In some embodiments, the dispenser arrangement defines a plurality of compartments. One compartment of the plurality of compartments is at least partially defined by each of the first base surface of a first divider of the plurality of dividers, the second base surface of a second divider of the plurality of dividers, the leading partition surface of a first partition of the array of partitions of the second divider, and the following partition surface of a second partition of the array of partitions of the second divider. In some embodiments, the dispensing system further comprises a housing that is dimensioned to enclose the dispenser arrangement. The housing includes a housing base and a housing cover. The housing cover is configured to be coupled to the housing base. In some embodiments, each opening of the plurality of dividers is dimensioned to be aligned in an axial direction to form a dispensing passageway. In some embodiments, the leading partition surface is configured to push a pill toward the dispensing passageway so that the pill can pass through at least one of the dividers via the at least one divider's opening. In some embodiments, the dispenser arrangement includes a capping disk. The capping disk comprises a base, an array of partitions, and a stop member. The base has a first base surface opposite a second base surface. The array of partitions extends from the second base surface of the capping disk. The stop member is configured to engage the first stop member of a divider of the plurality of dividers to prevent relative movement between the divider and the capping disk. In some embodiments, the capping disk is in communication with an actuator configured to rotate the capping disk. The capping disk is configured to cause one or more dividers of the plurality of dividers to rotate when the stop member of the capping disk engages the first stop member of one of the dividers. In some embodiments, the actuator is in communication with a controller. The controller is configured to receive dispensing instructions.

According to another aspect, a dispensing system comprises a dispenser arrangement. The dispenser arrangement defines a rotation axis. The dispenser arrangement comprises at least one divider, a static support coupled to the at least one divider, a plurality of sub-cartridges, and a plurality of compartments. The at least one divider defines a base surface and a dispensing opening that extends through the base surface. The static support extends in an axial direction and offset from the rotation axis. Each sub-cartridge of the plurality of sub-cartridges is separated by the at least one divider. Each sub-cartridge of the plurality of sub-cartridge includes partitions that extend radially from a central hub of the sub-cartridge. The central hub includes a keyway or tab configured to engage a corresponding tab or keyway of a drive shaft to rotationally drive the plurality of sub-cartridges. The plurality of compartments is configured to retain a dispensable item. Each of the plurality of compartments is formed by two partitions and the base surface of the at least one divider.

In some embodiments, the at least one divider includes at least two dividers and the number of dividers is one less than the number of sub-cartridges. In some embodiments the partitions are angularly separated from each other about the rotation axis by a set angle. The dispensing openings of adjacent dividers are angularly offset from each other about the rotation axis by the set angle. In some embodiments, the at least one divider includes radial tabs that engage the static support. In some embodiments, the dispensing system further comprises a motor and a motor controller configured to control the motor based on dispensing instructions. In some embodiments, the at least one divider is configured to not rotate.

According to yet another aspect, a dispensing system for dispensing dispensable items comprises a housing base and a dispenser arrangement. The housing base has a dispensing basin and a dispensing opening for retrieving a dispensable item. The dispenser arrangement has a plurality of sub-cartridges. Each of the plurality of sub-cartridges comprises a spacer and a cartridge cowl. The spacer has a central hub, a ramped surface, and a plurality of partitions that extend radially from the central hub. The cartridge cowl has a dispensing sector and a track configured to engage a holder of the spacer so that the cartridge cowl is rotatable relative to the spacer. The plurality of partitions and the ramped surface forms a plurality of compartments between each of the plurality of partitions. The plurality of compartments are dimensioned to hold the dispensable items. Each of the plurality of compartments is dimensioned to dispense the respective dispensable items when the respective dispensing sector is rotationally aligned with the compartment.

In some embodiments, at least one of the dispensing sectors includes a stop member that extends downward from the at least one dispensing sectors. In some embodiments, the stop member is configured to contact the dispensing sector on another sub-cartridge. In some embodiments, a bottom of each dispensing sector is open. The dispensable items within the plurality of compartments are configured to fall through the bottom of the dispensing sectors. In some embodiments, the dispensing basin comprises a ramped floor that funnels to the dispensing opening. In some embodiments, the spacers are configured as static disks and do not rotate.

### BRIEF DESCRIPTION OF THE DRAWINGS

FIG. 1 is a top isometric view of a dispensing system according to an embodiment of the present disclosure;

FIG. 2 is a bottom isometric view of the dispensing system of FIG. 1;

FIG. 3 is an isometric partial view of the dispensing system of FIG. 1 including a dispenser arrangement and a housing;

FIG. 4 is a top isometric view of the dispenser arrangement of FIG. 3 including a housing base of the housing;

FIG. 4A is a detail view of a compartment of the dispenser arrangement of FIG. 4;

FIG. 5 is a top view of a divider of the dispenser arrangement of FIG. 4;

FIG. 6 is a bottom view of the divider of FIG. 5;

FIG. 7 is a bottom isometric view of the divider of FIG. 5;

FIG. 8 is a top view of a capping disk of the dispensing system of FIG. 4;

FIG. 9 is a bottom view of the capping disk of FIG. 8;

FIG. 10 is a bottom isometric view of the capping disk of FIG. 8;

FIG. 11 is a side view of the dispenser arrangement of FIG. 4 and a partial cross section of the housing base;

FIG. 12 is a cross-sectional side view of the dispensing system taken along line 12-12 of FIG. 1;

FIG. 12A is a detail view of a housing connection of FIG. 12;

FIG. 13 is a cross-sectional side view of the dispensing system taken along line 13-13 of FIG. 1;

FIG. 14 is a side view of the dispenser arrangement and a cross-sectional view of the housing with dividers of the dispenser arrangement of FIG. 3 arranged in an exemplary orientation;

FIG. 15 is a side view of the dispenser arrangement and a cross-sectional view of the housing of FIG. 3, the dispensing system having been loaded with pills;

FIG. 16 is a partial side view of the dispenser arrangement of FIG. 15 in a dispensing state where a first pill is being moved from a first compartment of the dispenser arrangement;

FIG. 17 is a partial side view of the dispenser arrangement of FIG. 16 in a dispensing state where the first pill is moving through a dispensing passageway of the dispenser arrangement;

FIG. 18 is a partial bottom isometric view of the dispensing system of FIG. 1 in a dispensing state where a pill is being dispensed from the dispensing system;

FIG. 19 is a partial side view of the dispenser arrangement of FIG. 16 in a dispensing state where a first row of pills has been dispensed;

FIG. 20 is a partial side view of the dispenser arrangement of FIG. 19 in a dispensing state where another pill is being moved from another compartment of the dispenser arrangement;

FIG. 21 is a partial side view of the dispenser arrangement of FIG. 20 in a dispensing state where a second row of pills has been dispensed;

FIG. 22 is a partial side view of the dispenser arrangement of FIG. 3 in a fully dispensed state;

FIG. 23 is an exemplary matrix illustrating a dispensing order for the dispenser arrangement;

FIG. 24 is a partial cross-sectional view of a dispensing system according to another embodiment of the disclosure;

FIG. 25 is a top isometric view of a dispensing system according to another embodiment of the present disclosure;

FIG. 26 is a bottom isometric view of the dispensing system of FIG. 25;

FIG. 27 is a partial cutaway view of the dispensing system of FIG. 25, showing a partial view of a dispenser arrangement;

FIG. 28 is an exploded view of the dispensing system of FIG. 25;

FIG. 29 in an exploded view of a portion of the dispenser arrangement of FIG. 27;

FIG. 30 is another exploded view of a portion of the dispenser arrangement of FIG. 27;

FIG. 31 is a top isometric view of a sub-cartridge of the dispenser arrangement of FIG. 28;

FIG. 32 is a top view of the sub-cartridge of FIG. 31;

FIG. 33 is a bottom isometric view of another dispensing system, according to another embodiment of the present disclosure;

FIG. 34 is a partial cutaway view of the dispensing system of FIG. 33 showing a partial view of a dispenser arrangement;

FIG. 35 is a side view of a sub-cartridge of the dispenser arrangement of FIG. 34;

FIG. 36A is an isometric view of another dispensing system in a first position, according to another embodiment of the present disclosure;

FIG. 36B is an isometric view of the dispensing system of FIG. 36A in a second position;

FIG. 36C is an isometric view of the dispensing system of FIG. 36A in a third position;

FIG. 37 is a top isometric view of another dispensing system, according to another embodiment of the present disclosure;

FIG. 38 is a partially exploded bottom isometric view of the dispensing system of FIG. 37;

FIG. 39 is an isometric view of sub-cartridges of the dispensing system of FIG. 37;

FIG. 40 is an isometric view of a sub-cartridge of FIG. 39;

FIG. 41 is an isometric view of the dispensing system of FIG. 37 with a capping disk removed for clarity;

FIG. 42A is an isometric view of the dispensing system of FIG. 37 in a first position;

FIG. 42B is an isometric view of the dispensing system of FIG. 42A with an indication of rotation direction;

FIG. 42C is an isometric view of the dispensing system of FIG. 42A in a dispensing position;

FIG. 42D is a side view of the dispensing system of FIG. 42C in a dispensing position, with the dispensing system shown in transparency for clarity; and

FIG. 43 is a schematic illustration of a dispensing control system, according to an embodiment of the present disclosure.

### DETAILED DESCRIPTION

The concepts disclosed in this discussion are described and illustrated with reference to exemplary arrangements. These concepts; however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items. While the dispensing system disclosed herein may be embodied in many different forms, several specific embodiments are discussed herein with the understanding that the embodiments described in the present disclosure are to be considered only exemplifications of the principles described herein, and the disclosed technology is not intended to be limited to the examples or orientations illustrated.

As noted above, it can be generally useful to regulate the distribution of dispensable items, dispensable consumables, and other materials, such as medication, including controlled substances, or ammunition including bullets or other projectiles, for example. Such regulation can be helpful to control dosage, prevent tampering, provide reminders, or generally secure items against unauthorized access. For instance, some medication recipients may have trouble remembering proper dosing or timing to take medications. Others may attempt to incorrectly distribute medication in contrast with their prescribed treatment plan. Embodiments of the present invention can address these and other drawbacks to medication and other dispensable distribution.

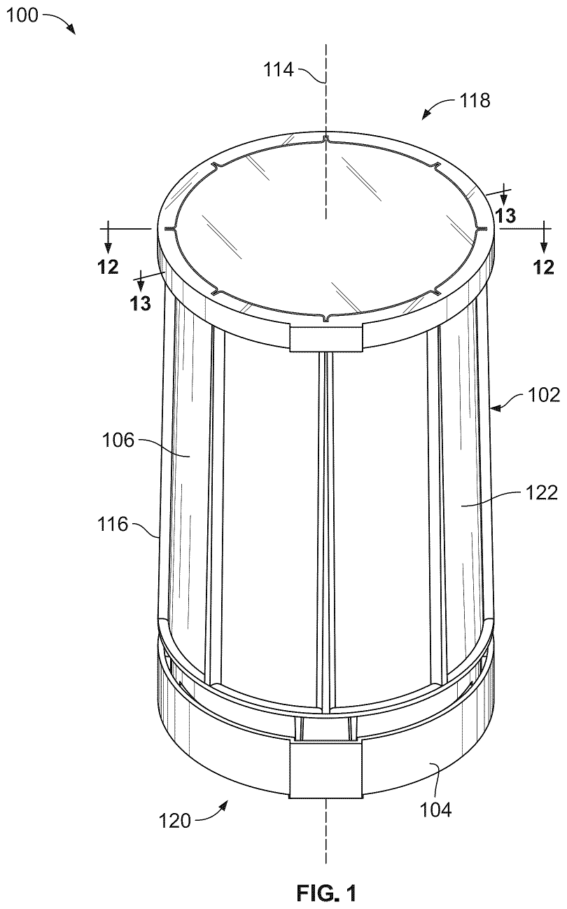

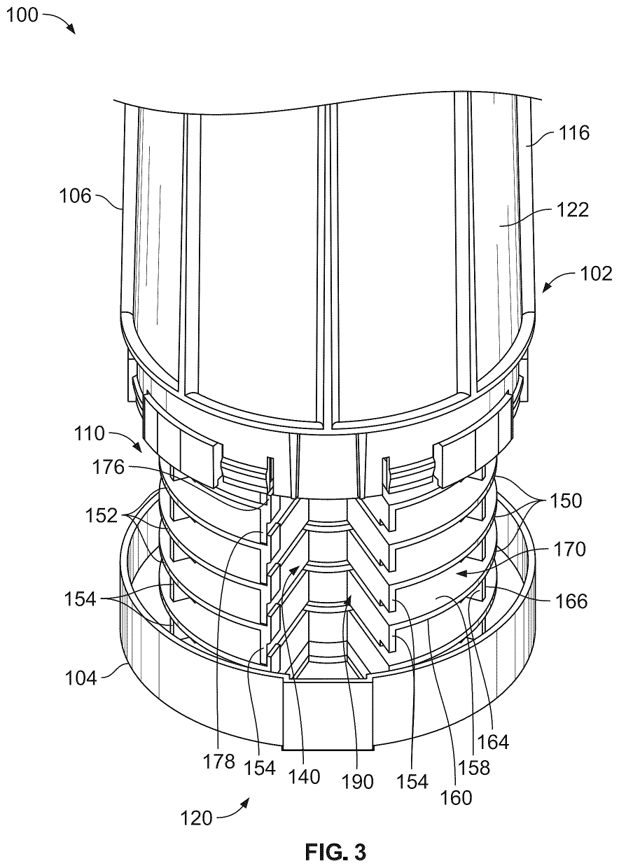

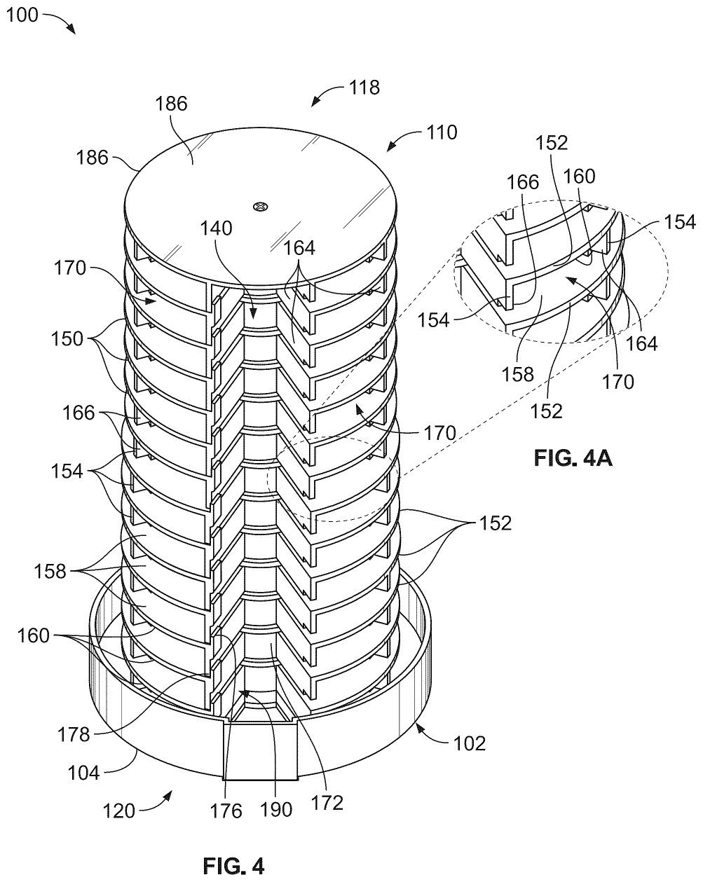

FIG. 1 illustrates a dispensing system 100 according to embodiments of the present disclosure. The dispensing system 100 includes a housing 102 having a housing base 104 and a housing cover 106. The housing 102 surrounds and encloses a dispenser arrangement 110 (see, e.g., the dispenser arrangement 110 in FIGS. 3 and 4). In some embodiments, once the housing cover 106 is coupled to the housing base 104, the dispenser arrangement 110 is secured within the housing 102 and generally inaccessible to an end user. For example, in use, a pharmacist or other technician may load the dispenser arrangement 110 with medication (e.g., pills) for one or more treatment plans or durations, and then secure the dispenser arrangement 110 within the housing 102. Once the dispenser arrangement 110 has been secured, a patient or other user can take the dispensing system 100 and begin receiving their medication at prescribed intervals via a dispensing opening 112 without direct access to the dispenser arrangement 110. Thus, in some embodiments, the dispensing system 100 can provide a tamper-resistant of tamper-proof system for a patient to receive prescribe doses of a medication.

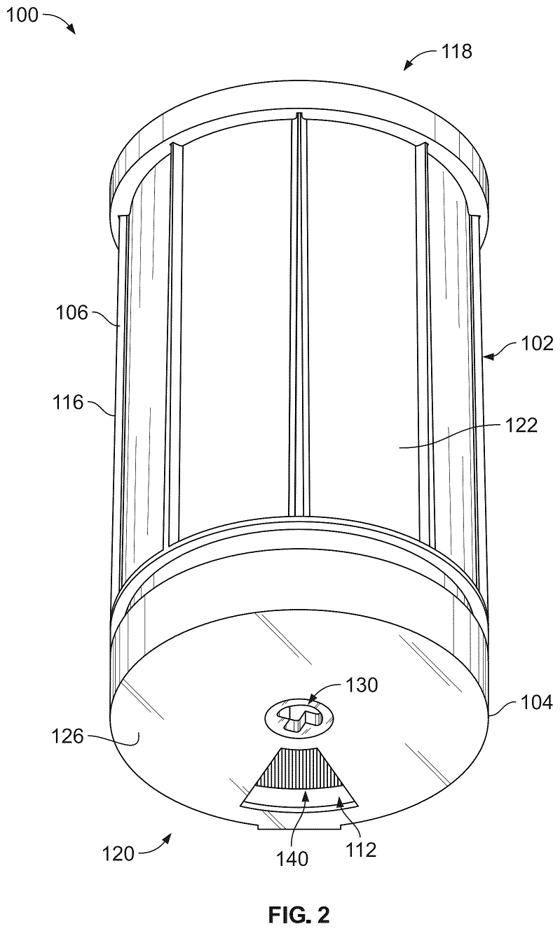

With reference to FIG. 2, the dispensing opening 112 can be formed in the housing base 104. However, in other embodiments, the dispensing opening 112 can be formed in other areas of the housing 102. In general, the dispensing opening 112 allows a user to retrieve a pill from the dispensing system 100 while the housing 102 is in a secured configuration (e.g., as shown in FIGS. 1 and 2) without direct access to the dispenser arrangement 110. That is, the dispenser arrangement 110 may be locked within the housing 102, similar to a vending machine arrangement.

In general, the dispensing system 100 can define a cylinder-like geometry with an axis 114 (see FIG. 1). However, other geometries are possible, including cones, prisms, and other regular or irregular geometries. In the illustrated embodiment, for example, the dispensing system 100 can define a cylindrical body 116 having a top 118 and a bottom 120. The cylindrical body 116 can further include a circumferential side wall 122. Segments of the circumferential side wall 122 can include planar (e.g., flat) or curved surfaces. In the illustrated embodiment, pills can be dispensed out the bottom 120 of the dispensing system 100 at the dispensing opening 112, formed in a bottom surface 126 of the housing base 104. As also shown in FIG. 2, the bottom surface 126 of the housing base 104 can also include a keyway 130.

In use, the keyway 130 can provide a manual release or actuator for the dispenser arrangement 110. As described in further detail below, in general, the dispenser arrangement 110 is configured to dispense a particular dispensable material by moving (e.g., rotating) one or more of a plurality of dividers 150 (see, for example, FIGS. 3 and 4). The dispensing system 100 can include an actuator, such as a motor or other actuation device to drive a movable component of the dispensing system 100. In a variety of situations, such as an assembly of the dispensing system 100 or a loss of power to the actuator, the keyway 130 can be used to either unlock or manually actuate the dispenser arrangement 110. In some embodiments, the keyway 130 may be dimensioned to receive a specific key so that an unintended individual or tool cannot access the contents or otherwise actuate the dispensing system 100.

With continued reference to FIG. 2, the dispensing opening 112 defines a generally trapezoidal geometry or truncated sector. However, other geometries are possible, including circular, square, triangular, or other regular or irregular geometries. In some embodiments, the geometry of the dispensing opening 112 can be similar to a cross-sectional profile of a dispensing passageway 140 (as shown in FIGS. 3 and 4). The similar geometry can advantageously facilitate pill dispensing and retrieving so that the pills can exit the dispensing system 100 via an unobstructed passageway. The dispensing opening 112 expands moving radially in a direction moving away from the keyway 130 toward an outer perimeter of the housing base 104. In some embodiments, a second dispensing opening (not shown) may be provided along the housing base 104.

With reference now to FIGS. 3 and 4, the dispenser arrangement 110 of the dispensing system 100 is shown. As discussed above, the dispenser arrangement 110 is configured to be enclosed by the housing 102. The dispenser arrangement 110 can include the plurality of dividers 150. Each divider 150 can include a base 152 and a plurality of partitions 154. Each of the partitions can extend axially from the respective base 152 and be arranged circumferentially about the base 152 to divide the base into a plurality of sectors (e.g., truncated wedges). In the illustrated example, the dividers 150 are generally configured as disks; however, other base geometries are possible, such as hexagons, octagons, or other regular or irregular polygons.

Each base 152 of the plurality of dividers 150 can define a first base surface 158 and a second base surface 160. The first base surface 158 can be opposite the second base surface 160. In the context of the illustrated embodiment, and in an assembled configuration, the first base surface 158 can face upward (i.e., facing the top 118 of the dispensing system 100) and the second base surface 160 can face downward (i.e., facing the bottom 120 of the dispensing system 100); however, other orientations are possible. Furthermore, as shown in FIGS. 3 and 4, the plurality of partitions 154 can extend from the second base surface 160 of the respective base 152. In general, the dispensing system 100 can include the plurality of partitions 154, and each base 152 can include a sub-plurality of partitions 154. Every partition 154 can define a leading partition surface 164 and a following partition surface 166.

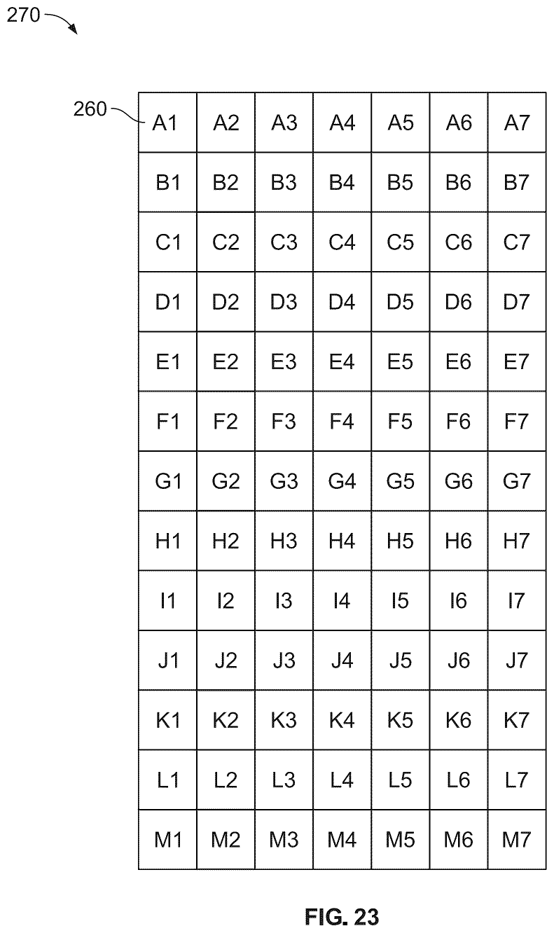

The dividers 150 and the partitions 154 can collectively define a plurality of compartments 170. In general, the plurality of dividers 150 can form a plurality of rows, and each row can include a sub-plurality of compartments 170. Thus, the dispenser arrangement 110 can include a plurality of sub-pluralities of compartments 170. As will be described further with reference to FIG. 23, the three-dimensional orientation of the compartments 170 can be represented as a two-dimensional matrix, where each sub-plurality of compartments 170 can be represented as a row in a matrix (e.g., a rectangular array).

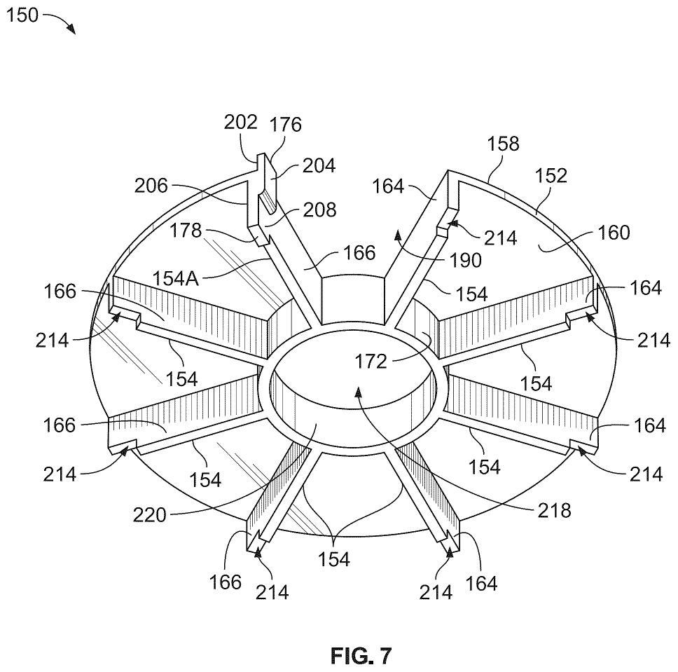

For example, as shown in FIG. 4A, one (or each) of the plurality of compartments 170 can be formed by the leading partition surface 164 of one partition 154, the following partition surface 166 of another partition 154, the first base surface 158 of one base 152, and the second base surface 160 of another base 152. Each compartment 170 can be further defined by a hub wall 172 (see, for example, FIG. 7). Thus, it takes two adjacent dividers 150 (or a divider 150 and a capping disk 186) to form the compartment 170, as well as two adjacent partitions 154. Each compartment 170 can be generally dimensioned to receive and contain a full or partial medication dose. For example, in some embodiments, each compartment 170 can hold a pill (e.g., capsule, tablet, etc.). In other embodiments, each compartment 170 can hold more than one pill or other dispensable item.

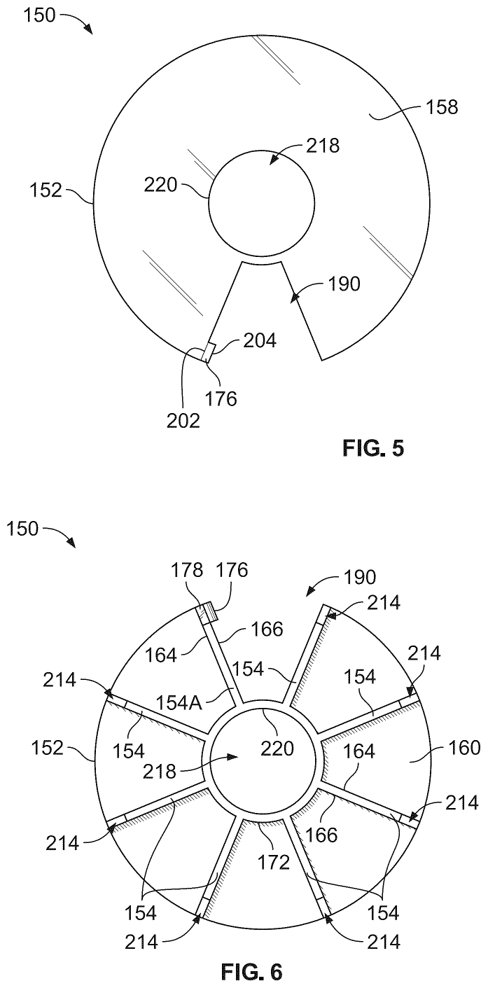

With continued reference to FIGS. 3 and 4, and further illustrated in FIGS. 5-7, each base 152 can also include first and second stop members 176, 178. The first and second stop members 176, 178 can extend from one partition 154 in the sub-plurality of partitions 154 so that each divider 150 includes one set of first and second stop members 176, 178. The first stop member 176 can generally extend upward in the axial direction from one partition 154, relative to FIGS. 3 and 4. Correspondingly, the second stop member 178 can generally extend downward in the axial direction from the same partition 154 as the first stop member 176. It should be appreciated that while the first and second stop members 176, 178 exist on each of the dividers shown in FIGS. 3 and 4, only several exemplary stop members 176, 178 are identified by a reference number to avoid overcrowding. Likewise, every divider 150, base 152, and partition 154 visible in FIGS. 3 and 4 are not necessarily identified by reference numbers.

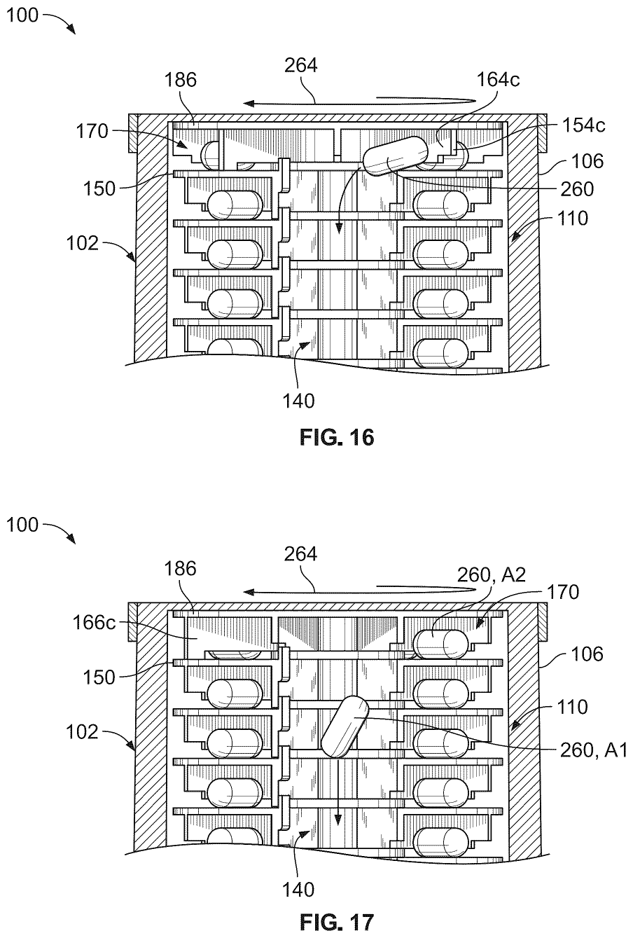

As shown in each of FIGS. 3-7, each divider 150 can further include an opening 190. The openings 190 can collectively form the dispensing passageway 140 through the dispenser arrangement 110. In use, each opening 190 of the plurality of dividers 150 is dimensioned to be aligned in an axial direction to form the dispensing passageway 140. Furthermore, each compartment 170 is configured to be in selective communication with the dispensing passageway 140. That is, depending on the position of each divider 150, a select pill from a select compartment 170 can move through the dispensing passageway 140 and out through the dispensing opening 112 when that select compartment 170 is in communication with the dispensing passageway 140. The communication of the compartments 170 with the dispensing passageway is described in further detail below with reference to FIGS. 16-22.

As further illustrated in FIGS. 3 and 4, the dividers 150 are dimensioned to be aligned in the axial direction (e.g., along the axis 114) and the dispensing passageway 140 can extend in the axial direction parallel to the axis 114. The length of the dispensing passageway 140 (in the axial direction) can vary depending on the rotational position of the dividers 150. For example, in the orientation shown in FIG. 4, the dispensing passageway 140 is at a maximum length since each opening 190 of each divider 150 is axially aligned. However, the length of the dispensing passageway 140 may be shortened as one or more dividers 150 are rotated. In general, the dispensing passageway 140 is defined by a passageway in communication with the dispensing opening 112 in the bottom 120 of the housing cover 106. Thus, if two or more openings 190 of the dispenser arrangement 110 are aligned, but not in communication (e.g., aligned) with the dispensing opening 112, then a sub-passageway may be formed inside the dispenser arrangement 110 which may not constitute the dispensing passageway 140.

In the illustrated embodiment, each opening 190 defines a generally trapezoidal geometry or truncated sector, similar to the dispensing opening 112 and also similar to the plurality of sectors formed by the partitions 154. Thus, as shown in FIG. 6, the partitions 154 can define eight distinct truncated sectors having a similar geometry. The eight sectors can be circumferentially spaced about the divider 150 and positioned radially outward from the hub wall 172. Seven of the sectors can form respective compartments 170 and the eighth sector can be the opening 190 that partially forms the dispensing passageway 140. In other embodiments, each divider 150 can be split into more or fewer segments with more or fewer partitions 154 so that more or fewer compartments are formed by a single divider 150.

With reference now to FIGS. 5-7, each divider 150 of the plurality of dividers includes the first stop member 176 and the second stop member 178. Like the partitions 154, the first and second stop members 176, 178 can define leading and following stop member surfaces. In general, the “leading” and “following” designation of surfaces are in the context of the direction of rotation of the dividers 150. For example, a “leading” surface moves in front of a “following” surface, relatively speaking, and thus, a “following” surface trails behind a “leading” surface. Though it should be appreciated that these leading and following surfaces are stationary with respect to each other on a single disk or divider 150, and “leading” and “following” is from a frame of reference outside of the dispensing system 100. Furthermore, it should be appreciated that the terms “leading” and “following” can be reversed if the direction of rotation of the dividers 150 is reversed.

FIG. 7 illustrates one exemplary divider 150 of the plurality of dividers in an isometric view so that a leading side 202 and a following side 204 of a first stop member 176 and a leading side 206 and a following side 208 of a second stop member 178 are shown (or at least represented). In use, when the leading side 206 of the second stop member 178 of one divider 150 is disengaged from the following side 204 of the first stop member 176 of another divider 150, the two dividers can rotate independently (notably in a first direction). However, when the leading side 206 of the second stop member 178 of the one divider is engaged with the following side 204 of the first stop member 176 of the other divider 150, then relative movement between the dividers is prevented (in the first direction).

As further shown in FIG. 7, each partition 154 that does not include the first and second stop members 176, 178 includes a cutout 214. Each cutout 214 is dimensioned to allow the first stop member 176 to pass by (or through) without the stop member engaging the partition 154 with the cutout 214. In the illustrated embodiment, the stop members 176, 178 and the cutouts 214 are formed at radially outward portions of the partitions 154. However, in other embodiments, the stop members 176, 178 and the cutouts 214 could be formed at other radial locations along the partitions 154.

With continued reference to FIG. 7 (and also shown in FIGS. 5 and 6), each divider 150 of the plurality of dividers can include a central opening 218. The hub wall 172 circumferentially sounds the opening 218 at a radially outward side of the opening 218. Furthermore, an internal hub wall 220 circumferentially surrounds the opening 218. In some embodiments, a shaft (not shown) can extend through the dispensing system 100 adjacent to the internal hub wall 220. As shown, the internal hub wall 220 forms a complete circuit so that the truncated sectoring opening 190 (and thus, the dispensing passageway 140) is separated from the central opening 218. As briefly described above, each base 152 of each divider 150 can include the sub-plurality (e.g., array) of partitions 154. In the illustrated embodiment, the partitions 154 extend from the second base surface 160. Thus, the partitions 154 extend axially downward (in the orientation shown). This configuration allows for pills (or other dispensables) seated on top of, for example, a first disk to be moved by the downwardly extending partitions 154 of a second disk located axially above the first disk.

As further illustrated in each of FIGS. 5-7, the stop members 176, 178 extend from one partition 154 of the sub-plurality of partitions 154 on each divider 150. In the illustrated embodiment, the stop members 176, 178 are disposed on the partition 154 adjacent to the opening 190 and, in particular, on a leading partition 154A relative to the opening 190. The leading partition 154A is circumferentially ahead of or in front of the opening 190 relative to the direction of rotation of the divider 150 when observed outside of the dispensing system 100.

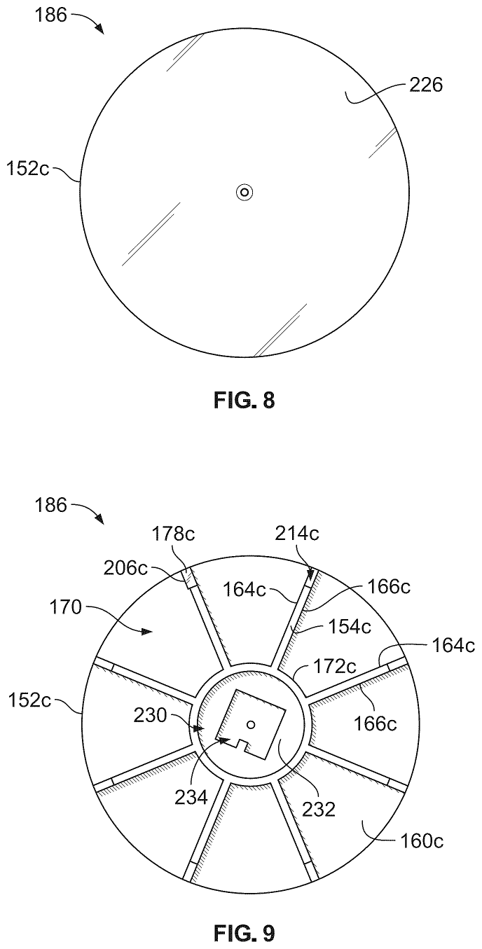

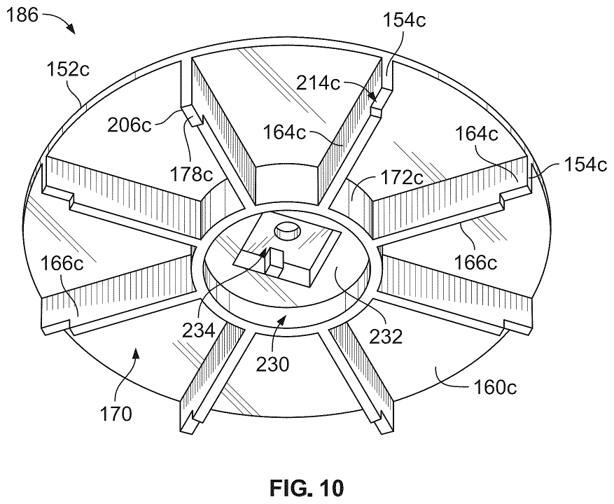

FIGS. 8-10 illustrate the capping disk 186. The capping disk 186 is generally similar to each divider 150 and includes substantially similar features. Such similar features will be described with like-reference numbers as the dividers 150, with an appended “c” to indicate components of the capping disk 186. For example, the capping disk 186 can include a base 152c and a plurality of partitions 154c, like the dividers 150. The base 152c can define a top surface 226 and a second surface 160c. Like the dividers 150, the second surface 160c of the capping disk 186 faces the bottom 120 of the dispensing system 100, and thus, faces the first base surface 158 of the adjacent divider 150.

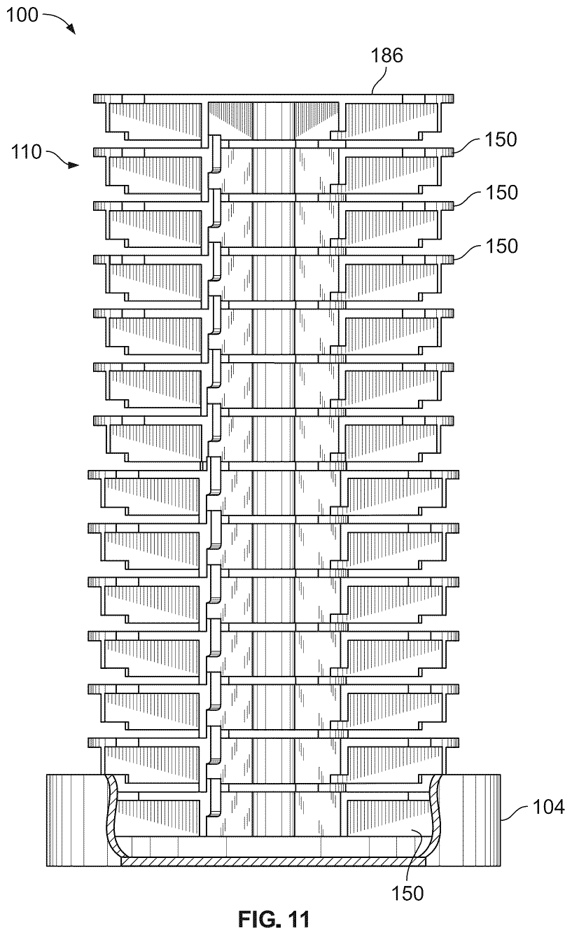

Each partition 154c can define a leading partition surface 164c and a following partition surface 166c. The plurality of partitions 154c can be an array of partitions 154c and each partition 154c can extend from the second base surface 160c of the capping disk 186. The capping disk 186 can further define the sub-plurality of compartments 170 (see, e.g., FIG. 11). Each compartment 170 of the sub-plurality of compartments 170 partially defined by the capping disk 186 can be defined by the first base surface 158 of a divider 150 adjacent to the capping disk 186, the second base surface 160c of the capping disk 186, the leading partition surface 164c of the capping disk 186, and the following partition surface 166c of the capping disk 186. Such compartments 170 can also further be defined by a hub wall 172c of the capping disk 186. Each segment of the hub wall 172c can be adjacent to a hub 230 of the capping disk 186. In the illustrated example, the hub 230 of the capping disk 186 can be configured as a closed hub having a closed end 232 adjacent to the top 226 of the capping disk 186.

The hub 230 of the capping disk 186 can further include a keyway 234. In some embodiments, the keyway 234 can be configured to receive a shaft, rotation member, or other motorized element or actuator configured to rotationally drive the capping disk 186. In some embodiments, the capping disk may be the only member of the dispenser arrangement 110 to receive a powered (e.g., rotational) input. Thus, the capping disk 186 can be configured as a drive member for the dispenser arrangement 110.

With continued reference to FIGS. 8-10, like the dividers 150, the capping disk 186 can include cutouts 214c in the partitions 154c that allow the stop member 176 of the adjacent divider 150 to pass by (or through). Thus, the capping disk 186 is configured to rotate in a first direction (e.g., a dispensing direction) relative to the adjacent divider 150 until the first stop member 176 of the adjacent divider 150 engages the stop member 178c of the capping disk 186 at a leading side 206c of the stop member 178c. Unlike the dividers 150, in the illustrated embodiment, the capping disk 186 does not include an opening 190. This allows the dispensing system to be sealed at a top side 118 when the capping disk 186 is secured to the dispenser arrangement 110. However, in other embodiments, the capping disk 186 could include an opening similar to the opening 190 and the dispenser arrangement 110 could still be sealed via the housing 102.

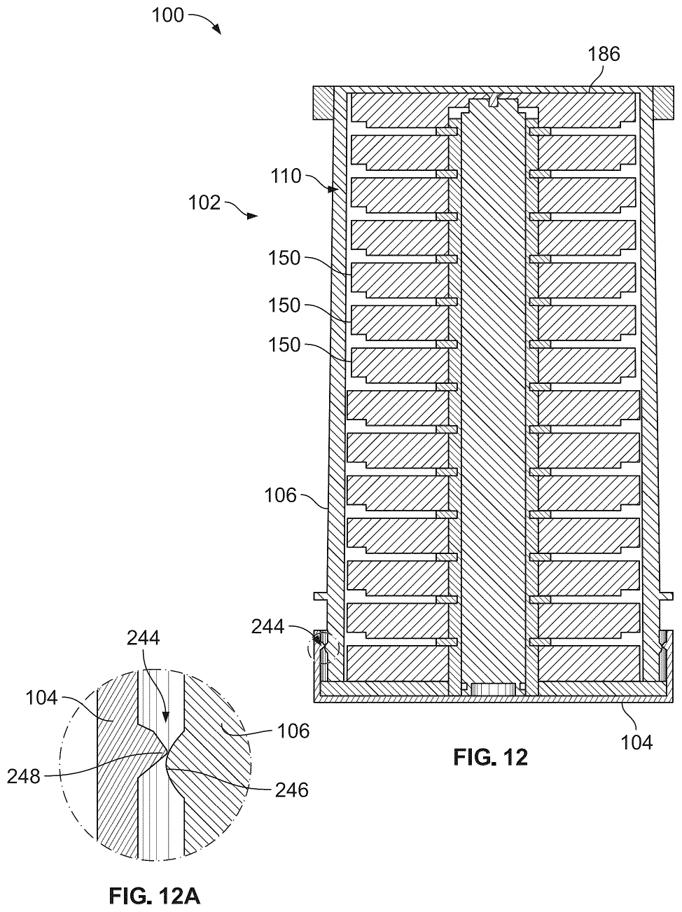

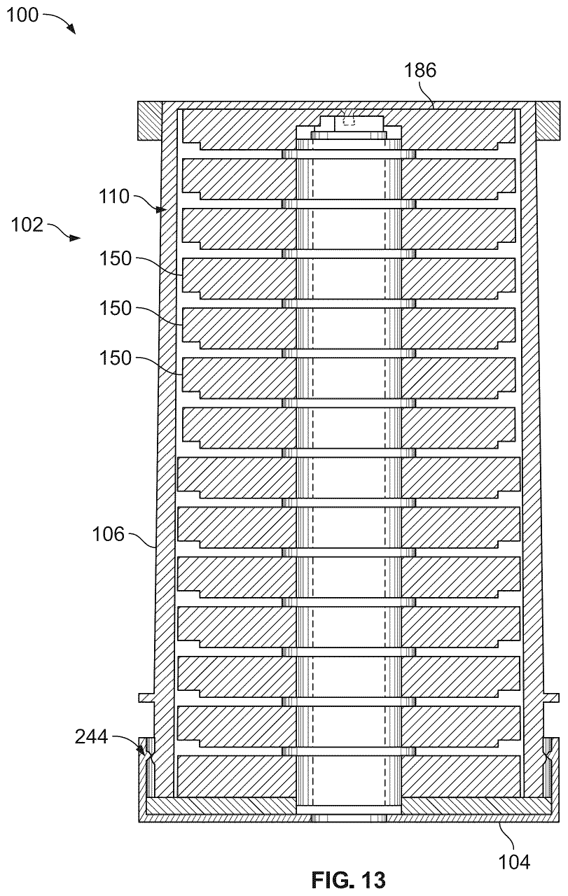

With reference now to FIGS. 11-13, the dividers 150 and the capping disk 186 are configured to be axially aligned to form the dispenser arrangement 110 of the dispensing system 100. FIG. 11 illustrates the dispenser arrangement 110 seated within the housing base 104 and the housing base 104 being partially cut away to illustrate a bottom-most divider 150 seated within the housing base 104. FIG. 12 illustrates the dispensing system 100 including the housing cover 106 secured to the housing base 104. In particular, FIG. 12A highlights an exemplary engagement of the housing cover 106 with the housing base 104. In the illustrated embodiment, the housing cover 106 and the housing base 104 can form an interference fit 244. For example, the housing cover 106 can include a first protrusion 246 and the housing base 104 can include a second protrusion 248. The first protrusion 246 can be dimensioned to engage, interlock, or otherwise form a locking fit with the second protrusion 248.

As briefly described above, the housing 102 can generally provide a tamper-proof or tamper-resistant enclosure around the dispenser arrangement 110 so that a patient or other end-user cannot access the contents of the dispensing system 100 beyond the prescribed dispensing from the dispensing opening 112. Thus, the interference fit 244 may provide a one-way closure such that the housing cover 106 is not removable from the housing base 104. In other examples, the housing cover 106 may only be removed from the housing base 104 via a key or other specific unlocking arrangement. In some embodiments, the first and second protrusions 246, 248 can be configured as annular protrusions at the respective housing cover 106 and housing base 104; however, other locking systems are contemplated.

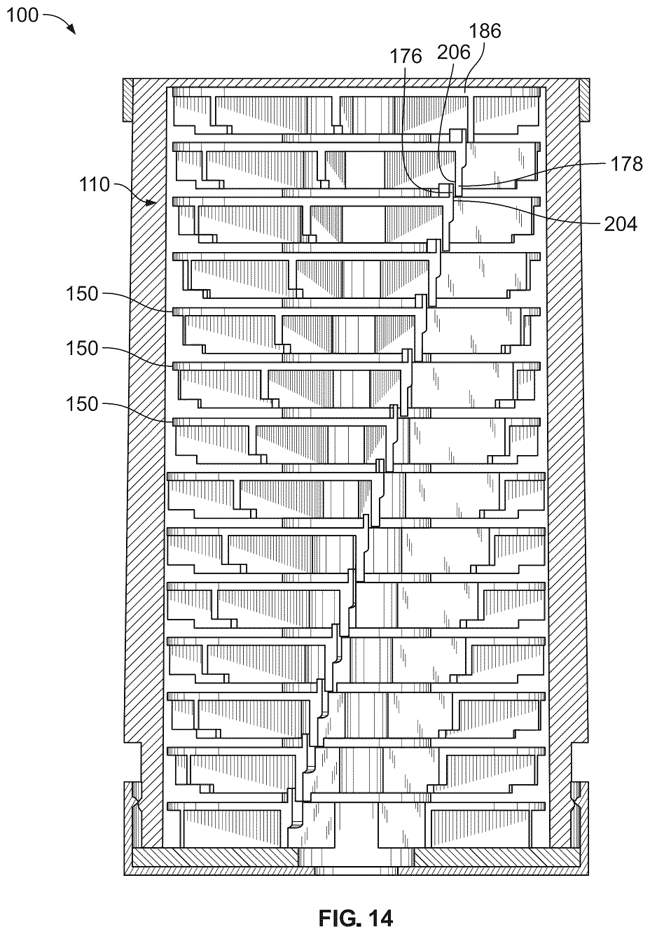

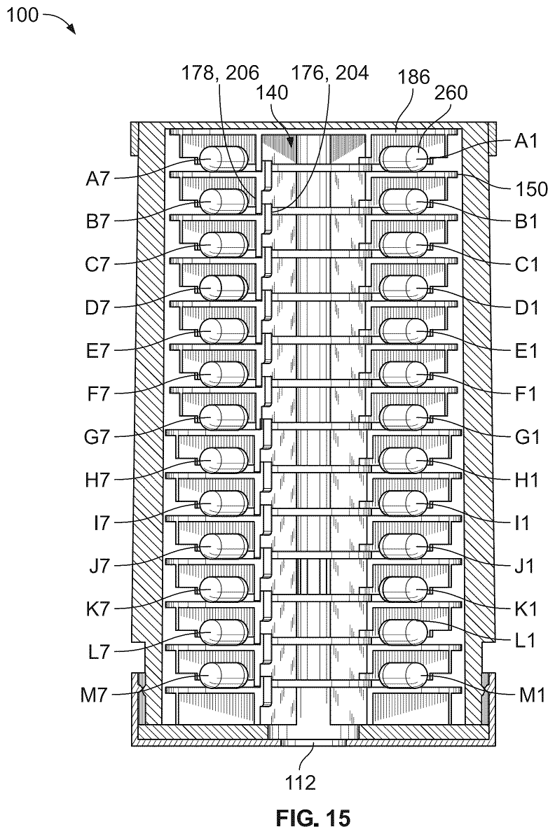

FIG. 14 illustrates an orientation of the dispensing system 100 where the leading side 206 of the second stop member 178 is engaged with the following side 204 of the first stop member 176 for each divider 150. In this orientation, rotation of the capping disk 186 in a first direction causes each divider 150 to rotate in the same direction. The orientation shown in FIG. 14 may correspond to a partially or fully dispensed configuration. FIG. 15 illustrates an orientation of the dispensing system where the leading side 206 of the second stop member 178 is not engaged with the following side 204 of the first stop member 176. In this orientation, the capping disk 186 can rotate in a first direction relative to (e.g., independently from) the adjacent divider 150 (and all the other dividers 150). The orientation in FIG. 15 corresponds to a full (e.g., non-dispensed) configuration of the dispensing system 100. Thus, every compartment 170 contains a dispensable 260 (e.g., a pill). However, it should be appreciated that other dispensables are possible.

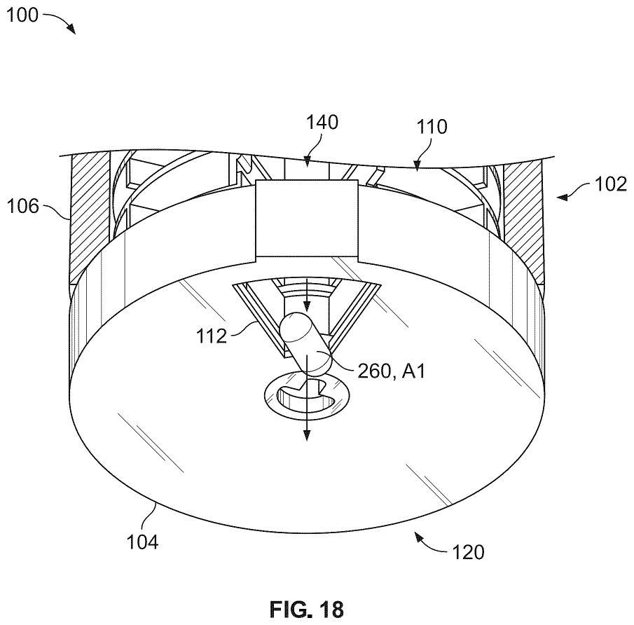

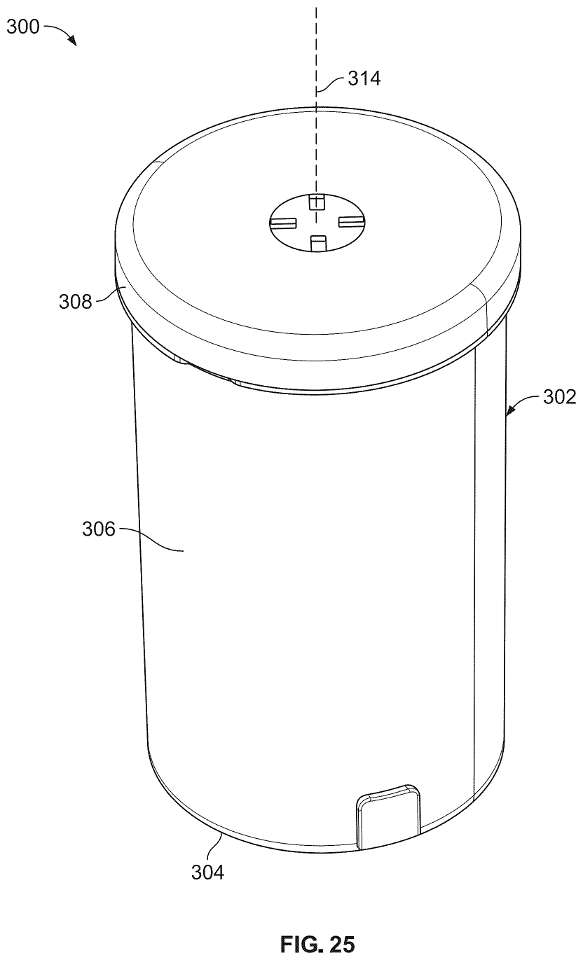

FIGS. 16-22 illustrate an exemplary usage of the dispensing system 100. For example, with reference to FIG. 16, in use, the capping disk 186 can be rotated in a first direction 264. As the capping disk 186 is rotated, the leading partition surface 164c of a first partition 154c can urge a first pill 260 (e.g., pill A1, with reference to FIG. 23) toward the dispensing passageway 140. As shown in FIGS. 17 and 18, the first pill 260 can move through the dispensing passageway 140 and be received by a patient or other end user at the dispensing opening 112. The first pill 260 (pill A1), and likewise, subsequent pills, may be dispensed according to dispensing instructions 300 (see FIG. 25) that can be relayed or programed to the dispensing system 100. The dispensing instructions 300 can be configured to instruct the dispensing system 100 to dispense one or more doses at prescribed times, intervals, or other parameters designated by a treatment plan. Once the first pill 260 (pill A1) has been dispensed, the subsequent pill 260 (pill A2) is queued up and ready to be dispensed next.

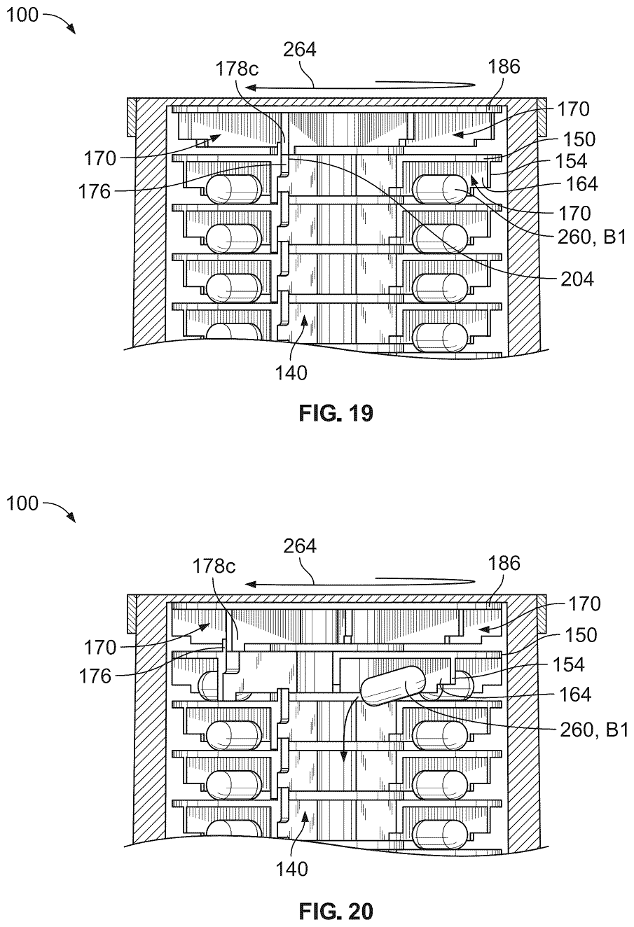

With reference to FIG. 19, the exemplary orientation of the dispensing system 100 represents a partially dispensed configuration. In particular, in the illustrated orientation, the top row or top sub-plurality of compartments 170 have been emptied and the pills 260 from the top row (e.g., pills A1-A7) have been dispensed. In this configuration, the capping disk 186 has been rotated almost 360 degrees in the first direction 264 (compared to the orientation shown in FIG. 15) so that the stop member 178c of the capping disk 186 is engaging the following side 204 of the first stop member 176 of the adjacent divider 150.

Referring to the orientation shown in FIG. 19, once the dispensing system 100 receives further dispensing instructions, the capping disk 186 can rotate in the first direction 264, which will cause the adjacent divider 150 to simultaneously rotate in the first direction 264. With respect to the example orientation shown in FIG. 19, when the capping disk 186 rotates, and thus the adjacent divider 150 rotates, the leading partition surface 164 of the first partition 154 can begin to urge a pill 260 (e.g., pill B1) toward the dispensing passageway 140, as shown in FIG. 20.

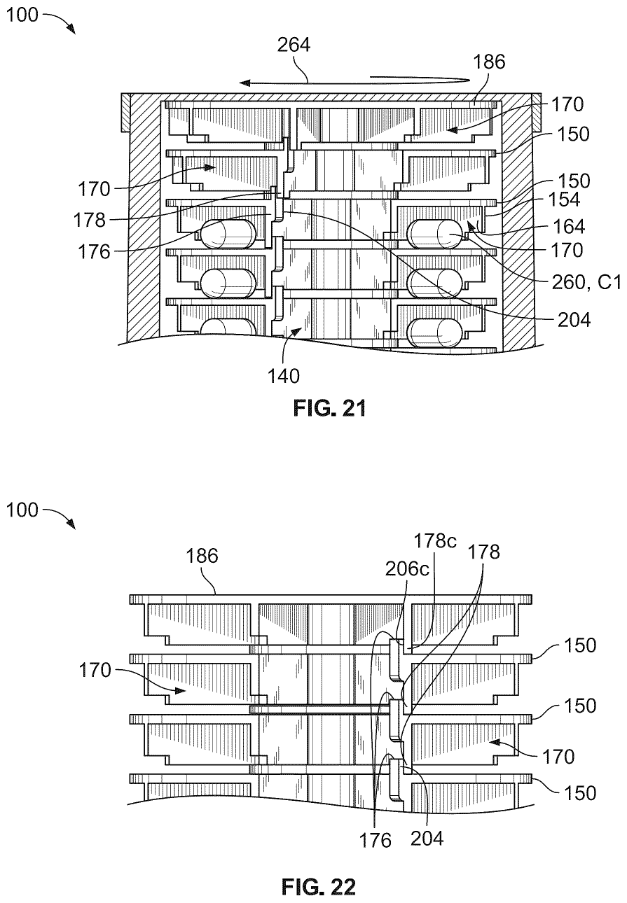

FIG. 21 illustrates another exemplary orientation of the dispensing system 100 in a partially dispensed configuration. In particular, in the illustrated orientation, the first and second rows (e.g., the top two rows) of the sup-plurality of compartments 170 have been emptied and the pills from those two rows (e.g., pills A1-A7 and B1-B7) have been dispensed. In this configuration, the divider 150 adjacent to the capping disk 186 has been rotated almost 360 degrees in the first direction 264 (compared to the orientation shown in FIG. 19) so that the second stop member 178 of the divider 150 adjacent to the capping disk 186 is engaging the following side 204 of the first stop member 176 of the subsequent divider 150.

Referring to the orientation shown in FIG. 21, once the dispensing system 100 receives further dispensing instructions, the capping disk 186 can rotate in the first direction 264, which will cause the adjacent dividers 150 to simultaneously rotate in the first direction 264. With respect to the example orientation shown in FIG. 21, when the capping disk 186 rotates, and thus the adjacent dividers rotate 150, the leading partition surface 164 of the first partition 154 can begin to urge a pill 260 (e.g., pill C1) toward the dispensing passageway 140.

FIG. 22 illustrates another exemplary orientation of the dispensing system 100. In this orientation, the dispensing system 100 may be partially or fully dispensed. As shown, the visible compartments 170 of the dispensing system 100 are empty. Thus, for example, the configuration shown in FIG. 22 can represent at least pills A1-A7, B1-B7, C1-C7, and D1-D7 having been dispensed. Furthermore, in the configuration shown in FIG. 22, each visible first stop member 176 is engaged with a corresponding second stop member 178, 178c of the adjacent divider 150 (and capping disk 186) so that the leading side 206 of the second stop member 178, 178c is engaged with the following side 204 of the first stop member 176.

In general, the dispensing system 100 can operate by rotating that capping disk 186 to either dispense a top row of pills 260 or cause subsequent dividers 150 to rotate to dispense subsequent rows of pills 260. Subsequent dividers 150 can rotate when the preceding divider 150 engages a stop member 176, 178, and thereby rotationally couples the adjacent dividers 150. For example, in use, the capping disk 186 rotates independently until it is rotationally coupled to a first divider 150. The capping disk 186 and the first divider 150 can then be rotated independent of the remaining dividers until the first divider 150 is rotationally coupled to a second divider 150. The capping disk and first and second dividers 150 can then be rotated independent of the remaining dividers until the second divider is rotationally coupled to a third divider 150, and so on until all of the dividers 150 in the dispenser arrangement 110 have been rotationally coupled. Rotation of the capping disk 186 and each divider 150 allows for every compartment 170 to be selectively moved into communication with the dispensing passageway 140 so that each pill 260 can be dispensed according to dispensing instructions 300.

FIG. 23 shows an exemplary matrix 270 of pills 260 to illustrate a dispensing order. The exemplary dispensing order of FIG. 23 includes pills arranged in rows that are ordered numerically and columns that are ordered alphabetically. It should be appreciated that the order and dimension of the matrix 270 is by way of example, and other dispensing orders and pill quantities are possible. In the illustrated example, the pills 260 can be dispensed by row so that the first dispensed pill is A1, the second dispensed pill is A2, and so on. Once the first row has been dispensed, the second row can be dispensed in the order of B1, B2, B3 and so forth. In the context of the embodiments described herein, each row and represent a sub-plurality of compartments 170 separated by dividers 150.

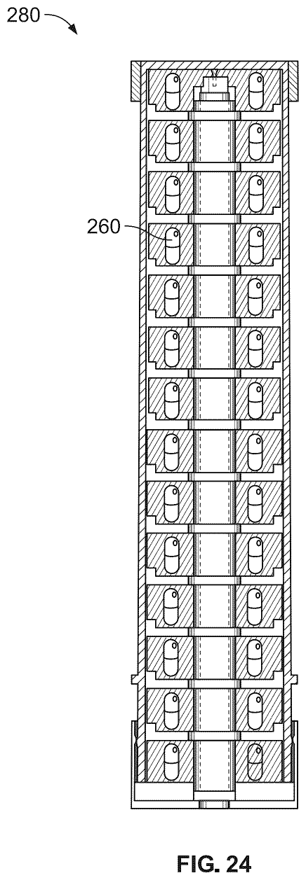

In some embodiments, when the dispensing system 100 is being loaded with pills (e.g., by a pharmacist or other medical professional or distributer), the pills may be loaded in a reverse dispensing order. That is, for example, the pills may be loaded starting with pill M7. In other embodiments, fewer or more rows and columns are possible. For example, if each divider of the dispenser arrangement includes ten partitions, then each divider may be split into ten sectors and can define nine compartments (and one opening in communication with a dispensing passageway). In this example, the exemplary dispensing array would include columns 1-9. In general, the dispensing system 100 illustrated in FIGS. 15-22 illustrate pills 260 being stored in a generally horizontal orientation (with respect to a pill axis). However, as shown in FIG. 24, other configurations are possible. For example, a dispensing system 280 can include pills 260 or other dispensables in a vertical orientation. This can reduce the radial dimension of the dispensing system and can allow for reduced footprint of the dispensing system.

In any of the dispensing systems described herein, including the dispensing systems 100, 270, a motor or other actuator can be used to rotationally drive or rotate the caping disk 186. The motor may be disposed on top of or below the housing 102. The motor can include a controller or be in communication with a controller that controls the rotation of the caping disk 186 (e.g., starting, stopping, speed, increment, timing, etc.). The controller can be preprogramed according to dispensing instructions, or can receive individual dispensing instructions via an external transmitter (e.g., a control transmitter at a pharmacy or from a smart phone). This can allow a variety of dispensing instructions to be uploaded and executed depending on the use of the dispensing system 100, 270. For example, dispensing instructions might differ or be changed depending on the environment that the dispensing system is used in, such as in an individual's home, a hospital, a pharmacy, assisted living, etc. As described above, in general, dispensing systems described herein provide a system for controlling the dispensing of medicine or other dispensable items. The controlled dispensing can be beneficial for those who need timed dispensing, to prevent or reduce excess medication from being ingested, and to secure medicine from tampering. As noted herein, the dispensing systems 100, 270 may be added into a dispenser (not shown) and the dispenser may rotate the dispensing system and/or the caping disk 186 to dispense the items within the dispensing system 100, 270.

In some embodiments, the controller can include software that enables the controller to perceive its environment or specific user needs and uses learning and intelligence to take actions that maximize chances of achieving defined goals. That is, in some embodiments, the controller can incorporate artificial intelligence (AI). In one nonlimiting example, the device (e.g., the dispensing system or a user interface for the dispensing system) via the controller can be asked to optimize strength and timing of dosages to optimize or maintain one or more biometrics of a patient or user. An example of this can include setting a parameter of an optimal glucose level or blood pressure for a patient. The controller can then be asked to optimize the timing and strength of medication dispensed via AI to keep the patient's glucose or blood pressure at or near the target parameter(s). In some embodiments, the AI can provide dosing recommendation or can adjust the internal program and dispensing after doctor approval.

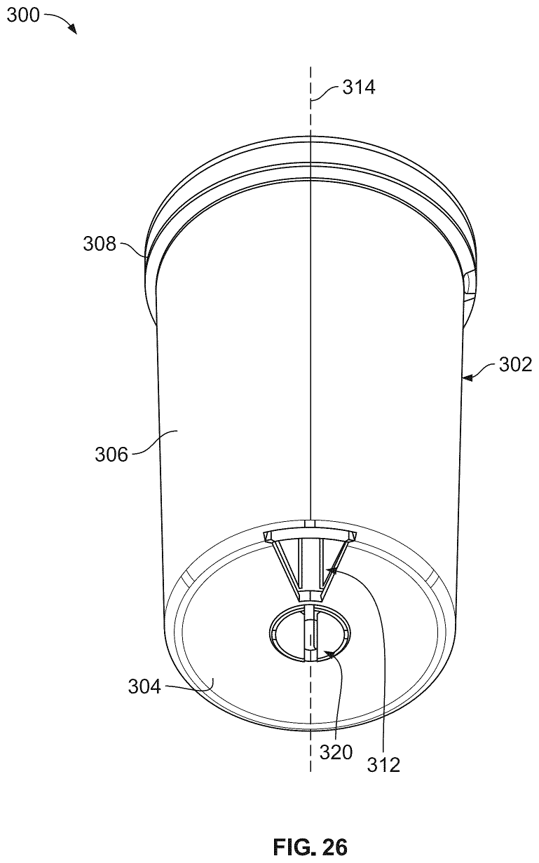

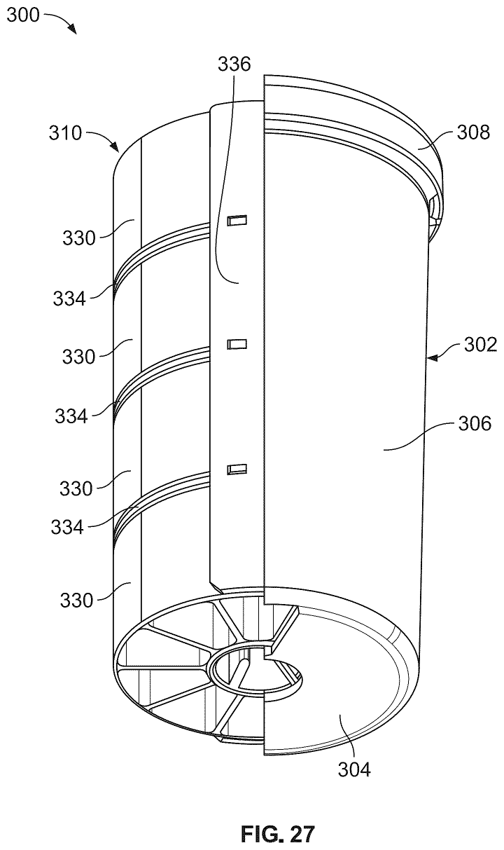

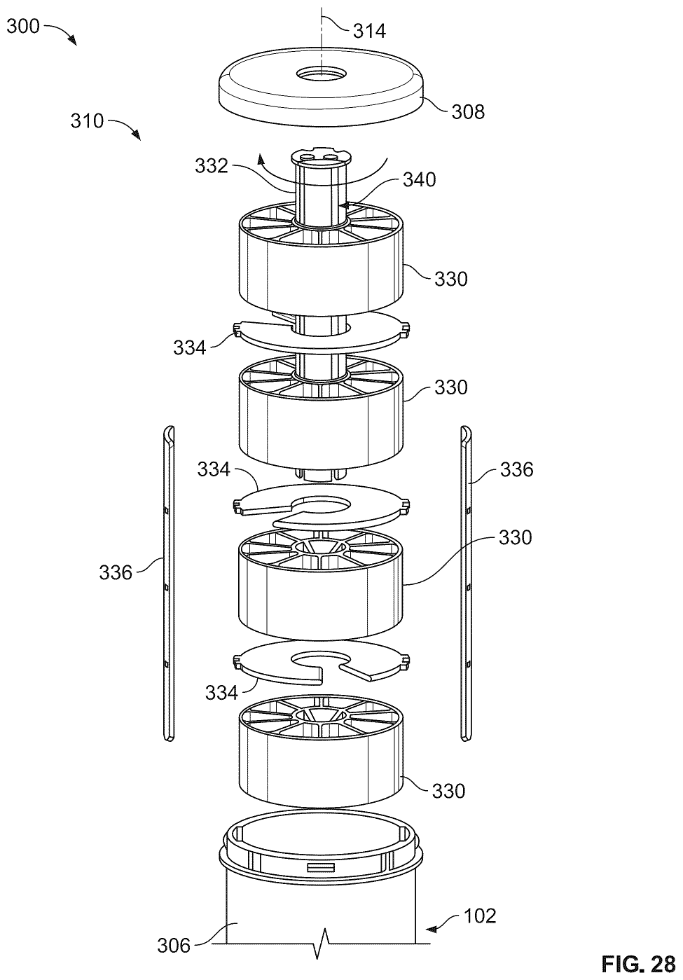

Referring now to FIGS. 25 and 26, a dispensing system 300 is illustrated according to another embodiment of the present disclosure. The dispensing system 300 includes a housing 302 having a housing base 304, a housing sidewall 306, and a housing cap 308. The housing 302 surrounds and encloses a dispenser arrangement 310 (see FIGS. 27 and 28). In some embodiments, once the housing 302 is closed (e.g., the housing base 304 and the housing cap 308 are secured relative to the housing sidewall 306), the dispenser arrangement 310 is secured within the housing 302 and generally inaccessible to the end user. For example, in use, a pharmacist or other technician may load the dispenser arrangement 310 with medication (e.g., pills) for one or more treatment plans or durations, and then secure the dispenser arrangement 310 within the housing 302. Once the dispenser arrangement 310 has been secured, a patient or other user can take the dispensing system 300 and begin receiving their medication at prescribed intervals via a dispensing opening 312 without direct access to the dispenser arrangement 310. Thus, in some embodiments, the dispensing system 300 can provide a tamper-resistant or tamper-proof system for a patient to receive prescribe doses of a medication.

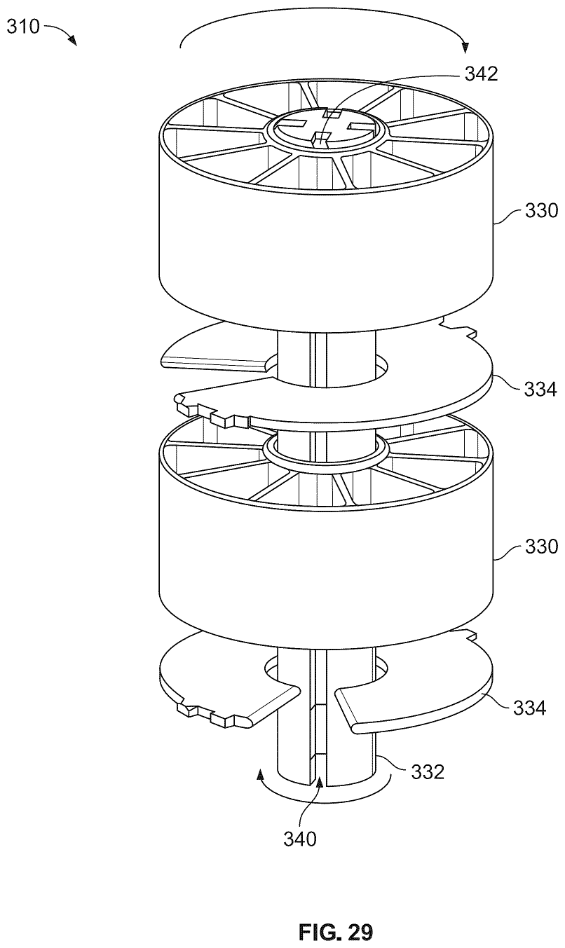

With reference to FIG. 26, the dispensing opening 312 can be formed in the housing base 304. However, in other embodiments, the dispensing opening 312 can be formed in other areas of the housing 302. In general, the dispensing opening 312 allows a user to retrieve a pill from the dispensing system 300 while the housing 302 is in a secured configuration (e.g., as shown in FIGS. 25 and 26) without direct access to the dispenser arrangement 310. That is, the dispenser arrangement 310 may be locked within the housing 302, similar to a vending machine arrangement. As also shown in FIG. 26, the bottom surface of the housing base 304 can also include a keyway 320. In use, the keyway 320 can provide a manual release or actuator for the dispenser arrangement 310. As described in further detail below, in general, the dispenser arrangement 310 is configured to dispense a particular dispensable material by moving (e.g., rotating) one or more sub-cartridges 330 (see, for example, FIGS. 28 and 29). The dispensing system 300 can include an actuator, such as a motor or other actuation device to drive a drive shaft 332 or other moveable component of the dispensing system 300. In a variety of situations, such as an assembly of the dispensing system 300 or a loss of power to the actuator, the keyway 320 can be used to either unlock or manually actuate the dispenser arrangement 310. In some embodiments, the keyway 320 may be dimensioned to receive a specific key so that an unintended individual or tool cannot access the contents or otherwise actuate the dispensing system 300.

Referring now to FIG. 27, a partial cutaway of the housing 302 is shown that partially illustrates the dispensing arrangement 310. The dispensing arrangement 310 includes the sub-cartridges 330, spacers 334, and static supports 336. In the illustrated embodiment, the dispensing arrangement 310 includes four sub-cartridges 330 and three spacers 334 disposed between each of the sub-cartridges 330. However, in other configurations, more or fewer sub-cartridges 330 and spacers 334 are possible. Referring to FIG. 28, an exploded view is shown of the dispensing system 300. As shown, each of the housing cap 308, the sub-cartridges 330, the spacers 334, the drive shaft 332, and the housing sidewall 306 are axially aligned along an axis 314. The drive shaft 332 is arranged to extend through each of the sub-cartridges 330 to rotationally drive at least one sub-cartridge, as indicated in FIG. 29. As further shown in FIG. 29, the drive shaft 332 can include one or more keyways 340 that can engage a corresponding tab 342 (or vice versa) of one or more sub-cartridge 330 so that the sub-cartridges 330 are rotationally locked (directly or indirectly) to the drive shaft 332 and the drive shaft 332 can cause one or more sub-cartridge 330 to rotate.

In the illustrated embodiment, each of the sub-cartridges 330 includes tabs 342 that engage the keyway 340 of the drive shaft 332 so that each of the sub-cartridges 330 rotates at the same time. In other embodiments, only one sub-cartridge 330 includes the tab 342 that engages the keyway 340 of the drive shaft 332 and a secondary tab that engages a subsequent sub-cartridge (similar to the origination used in the dispensing system 100). To that end, the first sub-cartridge with the tab 342 that engages the keyway 340 of the drive shaft 332 may complete a full rotation (e.g., 360 degrees) or near full before the secondary tab engages a subsequent sub-cartridge 330 causing both of the sub-cartridges 330 to rotate.

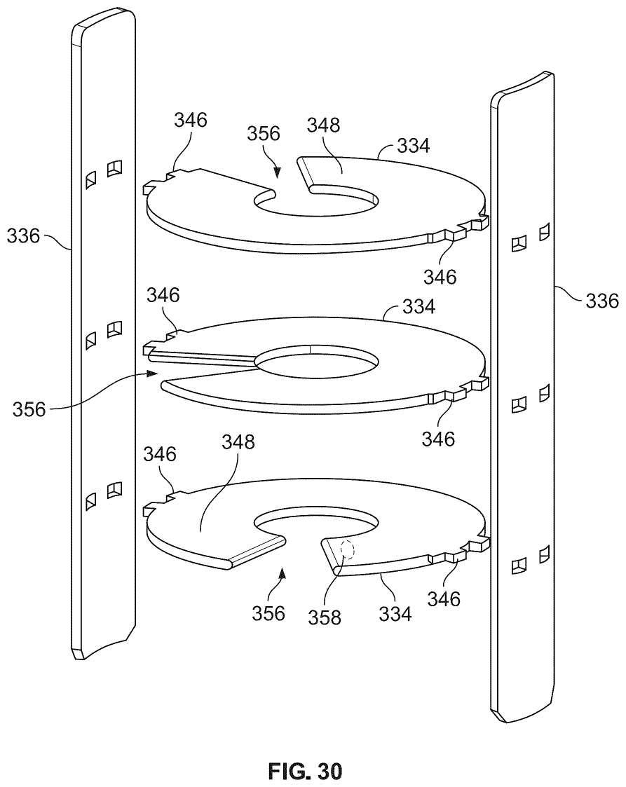

With reference to FIG. 30, the dispenser arrangement 310 also includes the static supports 336. The static supports 336 generally extend in the axial direction and engage the spacers 334 at an outer radial position of the spacers 334. In use, each of the spacers 334 and the static supports 336 remain stationary while the sub-cartridges 330 rotate (e.g., relative to the housing sidewall 306). The spacers 334 can include radial tabs 346 that are configured to engage with a mating recess of the static supports 336. However, it should be appreciated that in other embodiments, other static means of securing the spacers 334 to the static supports 336 are possible. For example, the static supports 336 could include tabs or recesses that are press fit or otherwise secured to the spacers 334.

With continued reference to FIG. 30, each spacer 334 can be generally configured as a static disk. The spacers 334 can define a spacer body having a base surface 348, and the base surface 348 can provide a surface on which one or more pills or other dispensable items are arranged. As will be described further below with reference to FIGS. 31 and 32, each of the sub-cartridges 330 can include a plurality of partitions 352 that at least partially form a plurality of compartments that hold the pills or other dispensable items. The compartments are formed in circumferential direction by the partitions 352 and in an axial direction by spacers 334 so that a pill can sit within the compartment, laterally bound by the partitions and seated on the base surface 348 of the spacer 334.

As further shown in FIG. 30, each spacer 334 can be generally configured as an annular ring with a dispensing opening 356 formed in the body of the spacer 334. The dispensing opening 356 is separate from the central opening that the drive shaft 332 extends through in that the drive shaft 332 does not extend through the dispensing opening 356. In the illustrated embodiment, the dispensing opening 356 is connected to the central opening that receives the drive shaft 332; however, in other embodiments, they may be separated by a physical barrier. Each dispensing opening 356 of the spacers 334 is rotationally offset from each other so that they do not align in the axial direction. This allows pills to be dispensed a single row at a time (a row being delimited in the axial direction by each spacer 334).

The dispensing openings 356 are angularly offset by the same angle as the partitions 352 of the sub-cartridge. That is, as shown in FIGS. 31 and 32, each sub-cartridge 330 includes ten partitions 352 to form ten compartments per row. The ten partitions 352 are angularly spaced by about 36° about the central axis. Thus, the dispensing openings 356 are offset by about 36° in the illustrated embodiment and as shown in FIG. 30. In other embodiments, other degrees of offset may be required. For example, if a sub-cartridge includes twelve partitions, then each partition may be angularly spaced about the central axis by 30° and the dispensing openings in the spacers may be offset by 30° about the central to accommodate the twelve partitions.

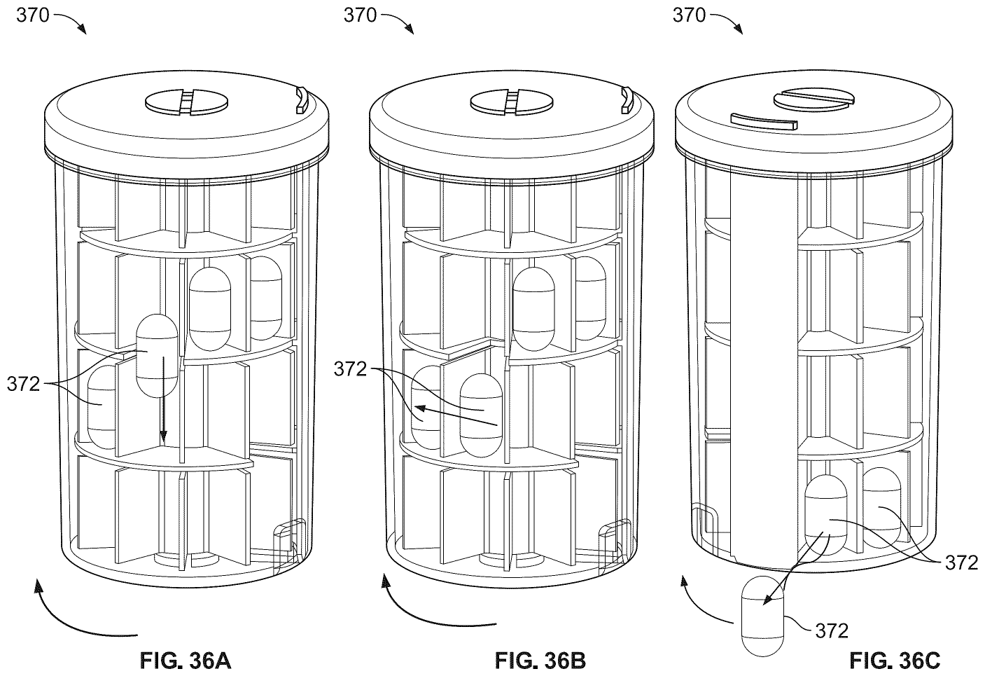

Still referring to FIG. 30, the dispensing openings 356 are offset in a counterclockwise direction (when viewed from the top down in FIG. 30). This corresponds to a dispensing direction in a clockwise direction (i.e., the drive shaft rotates 332 in a clockwise direction). In use, as the drive shaft 332 rotates, the compartments holding the pills rotate, and the partitions 352 of the sub-cartridges 330 urge the pills in a clockwise direction. The spacers 334 remain stationary, and the pill located at the pre-dispensing position 358 is urged through the dispensing opening 356 and dispensed. A circumferentially adjacent pill is then moved to the pre-dispensing position 358 to be dispensed next. Thus, the pills will make their way around the spacers 334, then down to the next spacer 334 through the dispenser opening 356, then around the spacer 334, and then down to the next spacer 334 and so on until the pill is in a pre-dispensing position 358 (similar process as shown in FIGS. 36A-36C).

FIGS. 31 and 32 illustrate one example of a sub-cartridge 330 of a plurality of sub-cartridges. The sub-cartridge 330 includes the partitions 352 that extend radially from a central hub 362 of the sub-cartridge. As shown in FIG. 32, the partitions 352 form compartments in which a pill 364 (or other dispensing product) can be placed. As described above, the pills 364 are arranged between the partitions 352 and seated on the base surface 348 of the spacer 334 directly below the respective sub-cartridge 330, i.e., the sub-cartridge 330 does not have a bottom under the compartments and the spacer 334 directly below the respective sub-cartridge 330 acts as the bottom to each compartment. However, in the case where there is no spacer 334 below the sub-cartridge (e.g., the bottom-most sub-cartridge), the housing base 304 or other component can provide a base surface on which the pills 364 are seated and moved along as the drive shaft 332 rotates the sub-cartridges.

Also shown in FIGS. 31 and 32, the central hub 362 includes the tabs 342 that engage the drive shaft 332. In the illustrated embodiment, there are four tabs 342 that extend radially inward into the opening formed by the central hub 362. The tabs 342 are configured to engage corresponding recesses or grooves of the drive shaft 332. However, in other embodiments, the drive shaft 332 can be a splined drive shaft that engages corresponding recesses or grooves in the sub-cartridges. Still in other embodiments, other attachment mechanisms to couple and rotationally lock the sub-cartridges 330 to the drive shaft 332 are possible. As also shown in FIG. 31, the sub-cartridge defines a height h, and in the illustrated embodiment the height is about 24.4 millimeters. In other embodiments, the height may be approximately between about 14 millimeters and about 35 millimeters, or approximately between about 19 millimeters and about 29 millimeters.

As discussed above, during use, the pills 364 will move around the drive shaft 332 within the compartments of multiple sub-cartridges 330. Put differently, as illustrated in FIGS. 29 and 30, a pill, e.g., the pill 364, may be positioned in the topmost sub-cartridge 330. As the sub-cartridge 330 rotates by the drive shaft 332, for example, the pill 364 will move around the drive shaft 332 within its respective compartment formed by the partitions 352 and the base surface 348 of the spacer 334 directly below the topmost sub-cartridge 330 until the pill 364 is positioned over the dispensing opening 356 of the spacer 334 directly below the topmost sub-cartridge 330. The pill 364 will then drop down, via gravity, through the dispensing opening 356 and to a compartment within the sub-cartridge 330 directly below the topmost sub-cartridge 330. The pill 364 will then move around the drive shaft 332 within this new compartment formed by the sub-cartridge 330 below the topmost sub-cartridge 330 until the compartment containing the pill 364 is positioned over the dispensing opening 356 of the spacer 334 directly below the sub-cartridge directly below the topmost sub-cartridge 330. The pill will then drop down, via gravity, through the dispensing opening 356 and into the next lower sub-cartridge 330. This process is repeated, depending on the number of sub-cartridges 330 and spacers 334, until the pill 364 is finally positioned over the dispensing opening 312. Once the pill 364 is positioned over the dispensing opening 312, gravity will cause the pill 364 to fall out of the dispensing system 300 and can be used by the user.

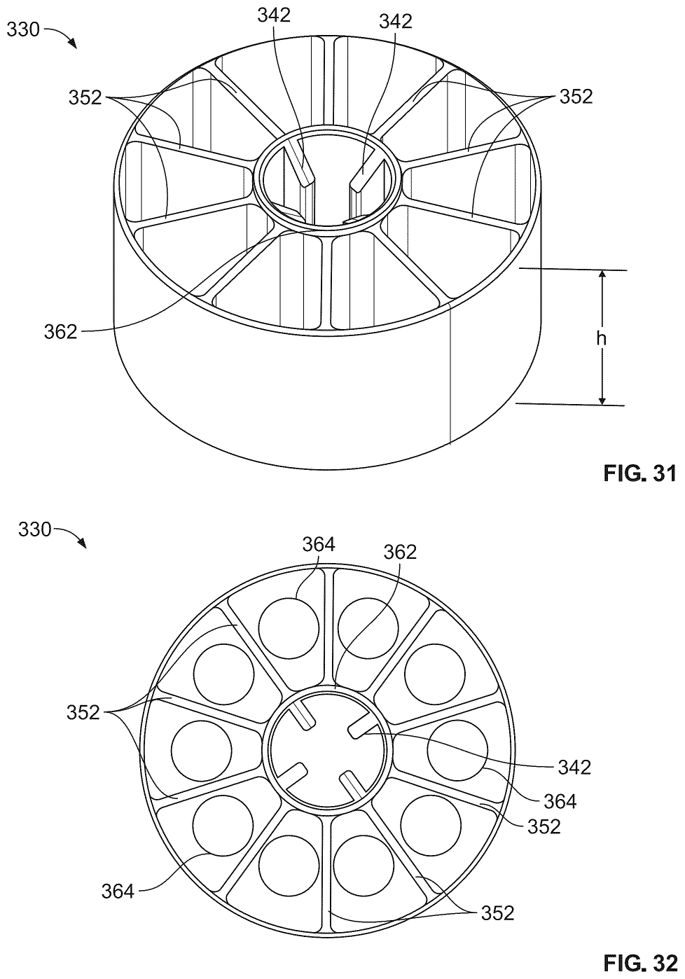

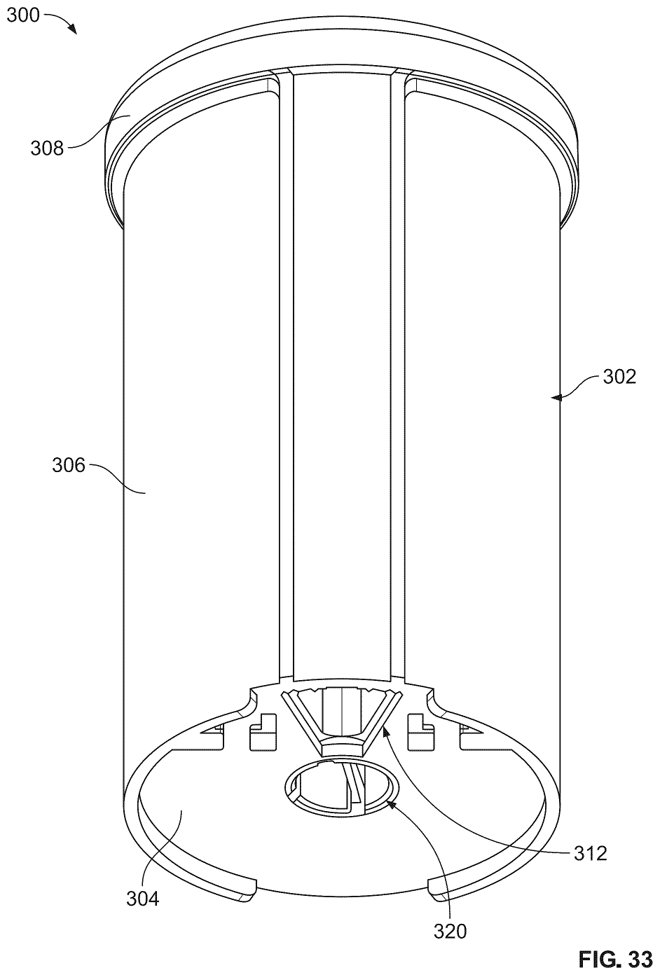

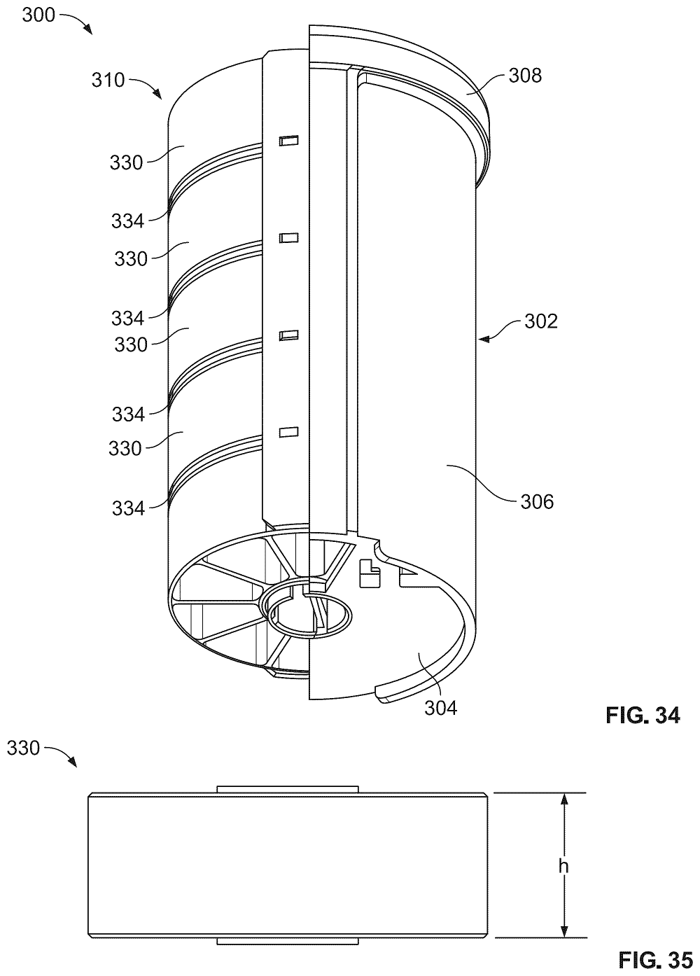

FIGS. 33-35 illustrate another embodiment of the dispensing system 300. Like reference numbers are used with regard to the alternative embodiment of the dispensing system 300. As noted herein, the dispensing system 300 shown in FIGS. 33-35 is very similar to the dispensing system 300 shown in FIGS. 25-32. The dispensing system 300 shown in FIG. 33 includes a housing 302 having a housing base 304, a housing sidewall 306 and a housing cap 308. Similar to the housing described above with reference to FIGS. 25 and 26, the housing 302 shown in FIG. 33 houses a dispenser arrangement 310, as shown in FIG. 34. As further shown in FIG. 33, the housing base 304 includes a dispensing opening 312 through which pills, or other dispensable items, can be dispensed via the dispenser arrangement 310. The housing base 304 can further include a variety of lock or retention features that can be used to secure the housing 302 to a secondary base or housing. The secondary base or housing can provide a foundation for the dispensing system 300 or provide connection to a motor or other dispensing actuator to actuate the dispenser arrangement 310. Furthermore, the housing base 304 includes a keyway 320. The keyway 320 can be substantially similar or the same as the keyway described above and shown in FIG. 26.

FIG. 34 shows the dispenser arrangement 310. The dispensing system 300 and dispenser arrangement of FIG. 34 is substantially similar to the dispensing system shown in FIG. 27; however, the dispensing system 300 shown in FIG. 34 includes five sub-cartridges 330 and four spacers 334. It should be appreciated that various embodiments of a dispensing system can include a variety of numbers of sub-cartridges, including less than five (e.g., see FIG. 27) or more than five. Further shown in FIG. 34, the dispenser arrangement 310 also includes a static support 336, similar to the static supports described above.

FIG. 35 shows a side view of one of the sub-cartridges 330 of FIG. 34. As shown, the sub-cartridge 330 shown in FIG. 35 defines a height h. In the illustrated embodiment, the height is about 19.16 millimeters. However, in other embodiments, the height may be approximately between about 9 millimeters and about 30 millimeters, or approximately between about 15 millimeters and about 24 millimeters. In some embodiments, a standard or consistent sized housing 302 may be used to house various dispenser arrangements having various configurations. For example, the same housing 302 may be able to house a dispenser arrangement 310 with four sub-cartridges (see FIG. 27) or a dispenser arrangement 310 with five sub-cartridges (see FIG. 34). However, in other embodiments, different sized housings 302 may be used to accommodate a variety of configurations of dispenser arrangements 310.

FIGS. 36A-36C illustrate another embodiment of a dispensing system 370. The dispensing system 370 operates substantially similarly to how the dispensing system 300 operates. In the embodiment shown, the dispensing system 370 allows pills 372 to be oriented in a vertical direction. However, in other embodiments, the pills 372 may be oriented in a horizontal or skewed direction. As shown, as sub-cartridges of the dispensing system 370 are rotated, which causes the pills in each row to translate circumferentially, and dispensed axially as each pill reaches the dispensing opening in each spacer.

In any of the dispensing systems described herein, including the dispensing systems 300, 370, a motor or other actuator can be used to rotationally drive the drive shaft 332. The motor may be disposed on top of or below the housing 302. The motor can include a controller or be in communication with a controller that controls the rotation of the shaft (e.g., starting, stopping, speed, increment, timing, etc.). The controller can be preprogramed according to dispensing instructions, or can receive individual dispensing instructions via an external transmitter (e.g., a control transmitter at a pharmacy or from a smart phone). This can allow a variety of dispensing instructions to be uploaded and executed depending on the use of the dispensing system. For example, dispensing instructions might differ or be changed depending on the environment that the dispensing system is used in, such as in an individual's home, a hospital, a pharmacy, assisted living, etc. As described above, in general, dispensing systems described herein provide a system for controlling the dispensing of medicine or other dispensable items. The controlled dispensing can be beneficial for those who need timed dispensing, to prevent or reduce excess medication from being ingested, and to secure medicine from tampering. As noted herein, the dispensing systems 300, 370 may be added into a dispenser (not shown) and the dispenser may rotate the dispensing system and/or the drive shaft 332 to dispense the items within the dispensing system 100, 270.

In some embodiments, the controller can include software that enables the controller to perceive its environment or specific user needs and uses learning and intelligence to take actions that maximize chances of achieving defined goals. That is, in some embodiments, the controller can incorporate artificial intelligence (AI). In one nonlimiting example, the device (e.g., the dispensing system or a user interface for the dispensing system) via the controller can be asked to optimize strength and timing of dosages to optimize or maintain one or more biometrics of a patient or user. An example of this can include setting a parameter of an optimal glucose level or blood pressure for a patient. The controller can then be asked to optimize the timing and strength of medication dispensed via AI to keep the patient's glucose or blood pressure at or near the target parameter(s). In some embodiments, the AI can provide dosing recommendation or can adjust the internal program and dispensing after doctor approval. In some embodiments, the dispensing system and/or the controller can include software that uses machine learning to advantageously assist the user achieve defined goals. In some embodiments, the dispensing system and/or controller can use AI and/or machine learning to learn and adapt to the user's needs, preferences, and schedules to help assist the user achieve defined goals. As noted herein, any of the dispensing systems described herein may incorporate AI and/or machine learning therein to advantageously assist the user.

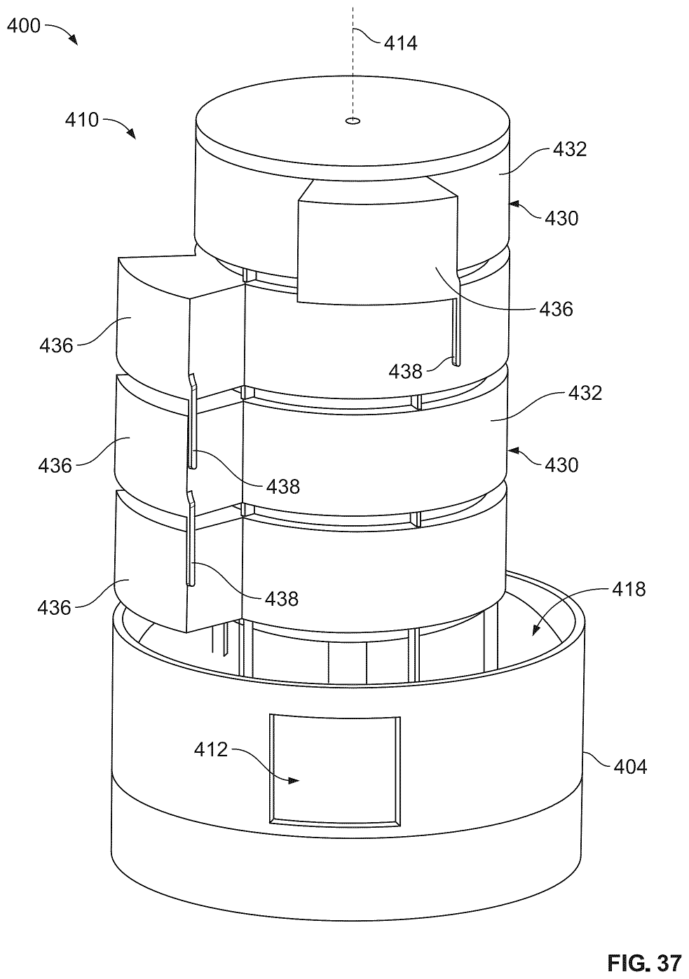

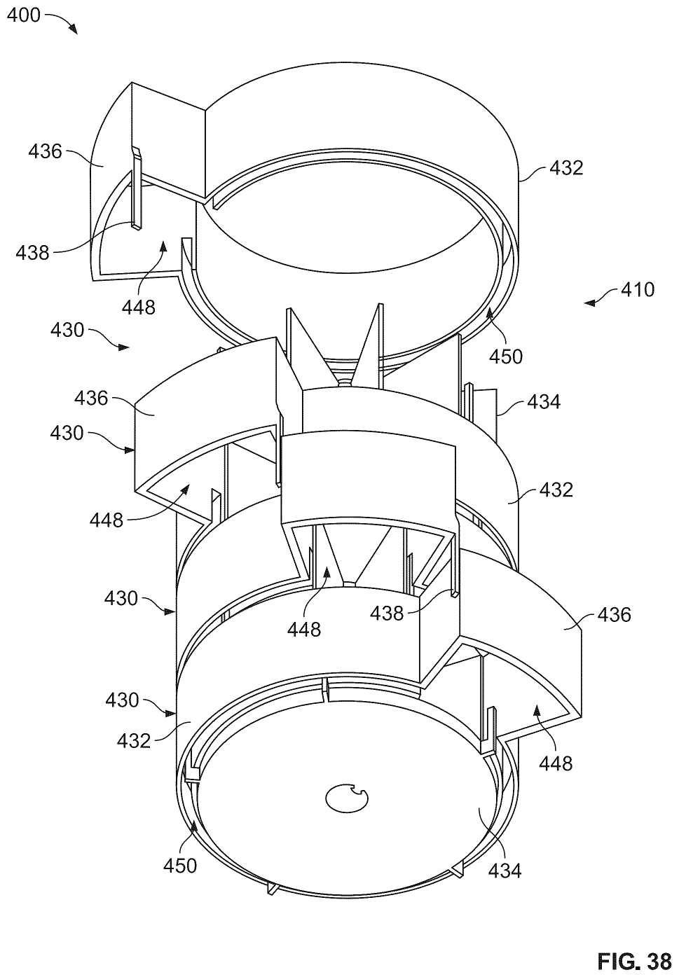

FIGS. 37-42D illustrate another embodiment of a dispensing system 400. FIG. 37 shows the dispensing system 400 having a housing base 404 and a dispenser arrangement 410. As noted herein, the dispensing system 400 can include a housing sidewall and/or a housing cap to enclose the dispenser arrangement 410. For ease of description, just the housing base 404 is shown. The housing base 404 includes a dispensing opening 412. The dispensing opening 412 is located on a lateral side wall of the housing base 404. However, in other embodiments, the dispensing opening 412 can be disposed elsewhere. The housing base 404 defines a dispensing basin 418. The dispensing basin 418 is in communication with the dispensing opening 412 so that a pill or other dispensable item can be dispensed into the dispensing basin 418 and retrieved at the dispensing opening 412.

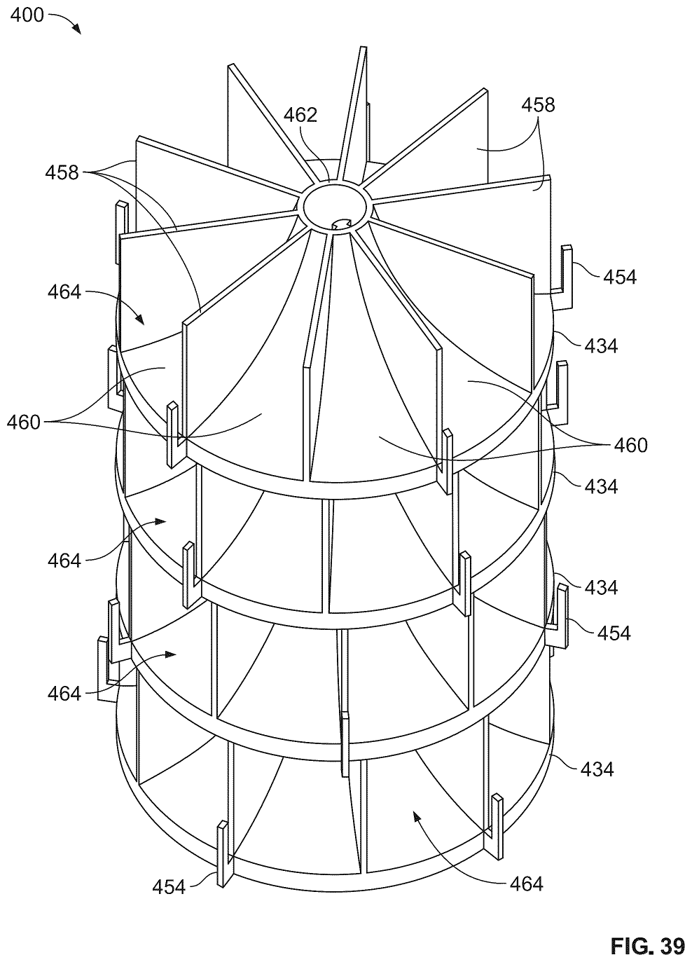

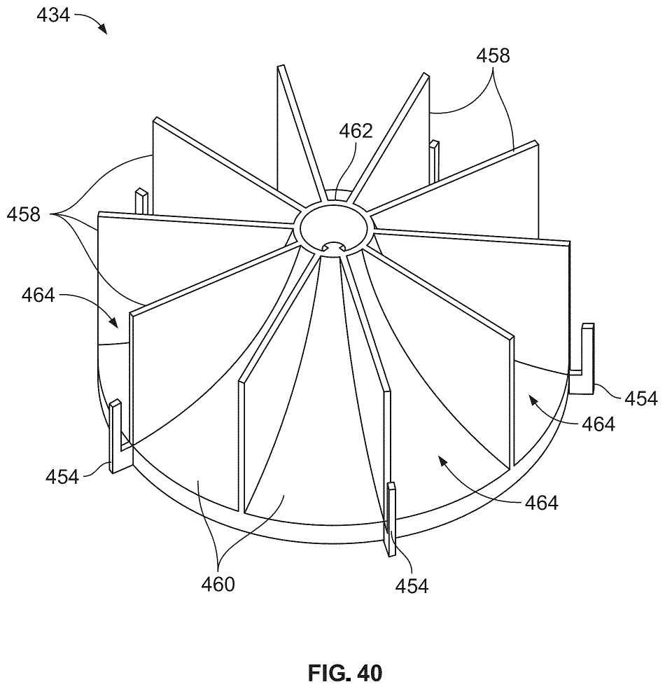

The dispenser arrangement 410 includes a plurality of sub-cartridges 430. As shown, the sub-cartridges 430 can be stacked to from the dispenser arrangement 410 and axially aligned with the housing base 404 along an axis 414. In use, the sub-cartridges 430 can rotate about the axis 414 to dispense pills or other dispensable objects loaded in the sub-cartridges 430. Each of the sub-cartridges 430 include a cartridge cowl 432 and a spacer 434 (see FIGS. 39 and 40). The cartridge cowl 432 includes a dispensing sector 436 that extends radially from the sub-cartridge 430. The cartridge cowl 432 can include a stop member 438 that extends axially from the dispensing sector 436. However, as shown in FIG. 37, the bottom-most sub-cartridge 430 does not include a stop member 438.

In use, the stop member 438 from one sub-cartridge 430 can engage the dispensing sector 436 of an adjacent sub-cartridge 430. Therefore, in use, for example, a first cartridge cowl 432 (e.g., the top-most cartridge cowl 432) can rotate independently from an adjacent cartridge cowl 432 until the stop member 438 of the first cartridge cowl 432 engages the dispensing sector 436 of the adjacent cartridge cowl 432. When the stop member 438 engages the dispensing sector 436 of the adjacent cartridge cowl 432, the adjacent cartridge cowl 432 can rotate dependently with the first cartridge cowl 432. Thus, in use, the last cartridge cowl 432 (e.g., the bottom-most cartridge cowl 432) rotates only when the cartridge cowls 432 above it has/have rotated so that the respective stop members 438 have engaged the respective dispensing sector 436 of the adjacent cartridge cowl 432.

In the example shown, dispensing occurs first from the top-most sub-cartridge 430. However, in other embodiments, depending on the direction of rotation, the position of stop members 438, or which cartridge cowl 432 is directly connected to a drive shaft 444, dispensing may occur in another order. Still in other embodiments, the cartridge cowls 432 may be configured to rotate independently to dispense pills or other dispensable items. In some embodiments, a motor can be housed within or disposed below the housing base 404 to rotationally drive the drive shaft 444. However, similar to the dispensing systems described above, other motor (and controller) configurations are possible and may be similar to those described above.

FIG. 38 shows a bottom exploded view of the dispenser arrangement 410. As shown, the bottom 448 of each dispensing sector 436 is open. In use, this allows a pill or other dispensable item to travel from the dispensing sector 436 down to the dispensing basin 418 of the housing base 404. In some embodiments, as discussed above, the dispensing system 400 can include a housing side wall that covers the dispenser arrangement 410 so that pills or other dispensable items are contained within the sub-cartridges 430 and the housing until the pill reaches the dispensing opening 412 in the housing base 404.

Each cartridge cowl 432 can also include a track 450. The track 450 can be configured as a groove or other feature that travels along a holder 454 of a respective spacer 434 (see FIGS. 39 and 40). In general, the track 450 allows the cartridge cowl 432 to rotate relative to the spacers 434. Thus, the spacers 434 may be configured as static disks. As the cartridge cowls 432 rotate, a pill is able to move through the dispensing sector 436 from a compartment 464 formed by radial partitions 458 of the spacer 434 and a circumferential wall of the cartridge cowl 432.

As shown in FIGS. 39 and 40, each of the spacers 434 includes radially extending partitions 458. In the illustrated example, each spacer 434 includes ten partitions 458, which correspond to ten compartments 464 per row of spacers 434. Thus, in the embodiment shown in FIG. 39, the dispensing system 400 is equipped to retain forty pills (with one pill per compartment 464). The compartments 464 that hold each pill (or in some instances, a plurality of pills) are bound by the partitions 458 on the side, a lateral surface of the cartridge cowl 432 (not shown in FIG. 39), and a ramped surface 460 of the spacer 434. The ramped surface 460 is ramped downward in a radially outward direction so that a pill placed in the compartment 464 is urged radially outward and downward via gravity, i.e., when oriented in the orientation shown in FIG. 39.

Like the partitions 352 of the dispensing system 300, the partitions 458 extend radially outward from a central hub 462 and along the axial direction. The central hub 462 can define an axial opening through which the drive shaft 444 extends. In some embodiments, the spacers 434 remain stationary relative to the drive shaft 444. In this embodiment, the drive shaft 444 would be coupled to one or more cartridge cowls 432 so that the cartridge cowls 432 are able to rotate relative to the spacer 434. However, in other embodiments, the hub 462 can include a key to engage with a corresponding keyway of the drive shaft 444 so that one or more spacers 434 is mechanically tied to the drive shaft 444 and thereby rotatable via the drive shaft. In such embodiments, the cartridge cowls 432 may remain stationary. Whether only the spacers 434 rotate, only the cartridge cowls 432 rotate, or both rotate, each compartment is configured to align with a dispensing sector 436 to dispense the pill contained in the compartment 464. In some embodiments, a connecting rod may connect each of the spacers 434 together, i.e., the connecting rod may connect the static elements together. In such an embodiment, the drive shaft 444 may be positioned between the connecting rod, i.e., the connecting rod surrounds the drive shaft 444 and causes the spacers 434 to be static while the drive shaft 444 allows the cartridge cowls 432 to rotate.

Still referring to FIGS. 39 and 40, each spacer 434 can include the holder 454 that guides and supports the cartridge cowl 432 and allows the cartridge cowl 432 to rotate relative spacer 434. In the illustrated embodiment, the holders 454 are disposed radially inline with the partitions 458 at every other partition. However, other configurations are possible, including more or fewer holders 454 that do not interfere with a pill moving from a compartment 464 to the dispensing sector 436. The holders 454 can allow for the dispenser arrangement 410 to be assembled via stacking. For example, during an assembly process, a first cartridge cowl 432 may be placed on a first spacer 434 to form a first sub-cartridge 430. The pills may then be loaded into each compartment 464 of the sub-cartridge. Subsequent sub-cartridges 430 may then be stacked thereon to form the dispenser arrangement.

As described above, gravity may assist the dispensing of pills from the compartments 464, particularly via the ramped surfaces 460 of the spacers 434. This gravitational dispensing can reduce the distance travelled by the pill from the compartment 464 to the dispensing basin 418. For example, in the embodiment where the cartridge cowl 432 rotates and the spacer 434 remains stationary to dispense pills, the pills do not have to travel in a circumferential direction and slide across a base surface. This can advantageously reduce wear and degradation on individual pills. Furthermore, a rotating cartridge cowl 432 and a stationary spacer 434 can prevent or reduce any cross-contamination between differing pills by reducing shared surfaces that individual pills contact.

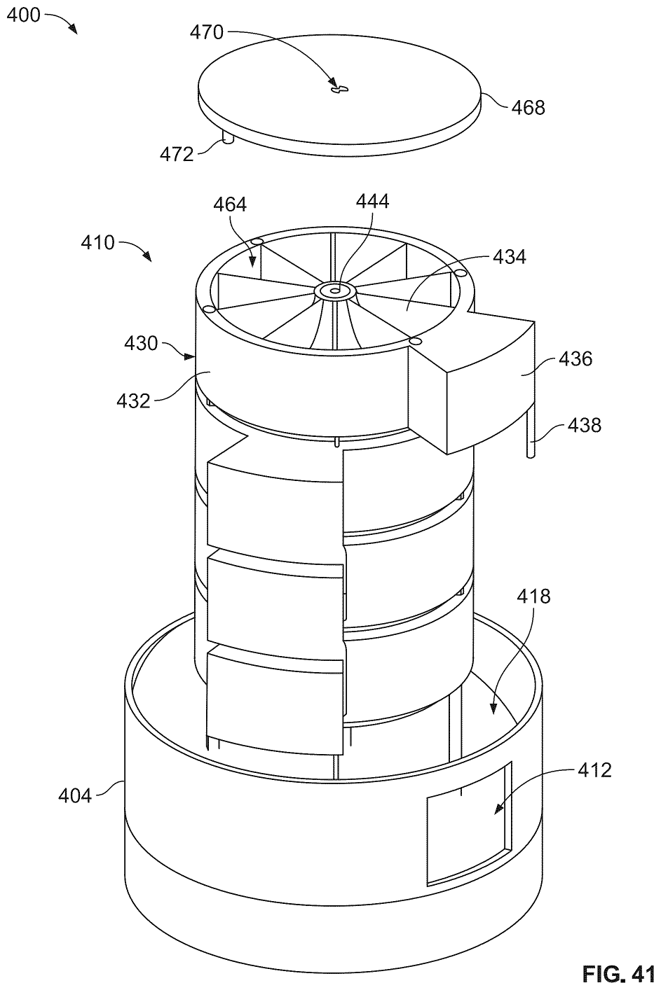

FIG. 41 illustrates one exemplary method by which the cartridge cowls 432 are rotatable. In the illustrated example, the dispensing system 400 includes a cap 468 having a keyway 470. The keyway 470 is configured to mechanically tie the cap 468 and the drive shaft 444 so that when the drive shaft 444 rotates, the cap 468 rotates. The cap 468 further includes couplers 472 to mechanically tie the cap 468 to the top-most cartridge cowl 432. The couplers 472 are configured as pegs that extend axially from the cap 468 and are received by corresponding recesses in the top-most cartridge cowl 432. In other embodiments, other coupling mechanisms are possible to mechanically tie the cap 468 to the top-most cartridge cowl 432 so that rotation of the drive shaft 444 corresponds to rotation of the top-most cartridge cowl 432. In some embodiments, as discussed above, a motor, actuator, or other device may rotate the cap 468 (via the drive shaft 444 in one embodiment) and thereby rotate the cartridge cowls 432.

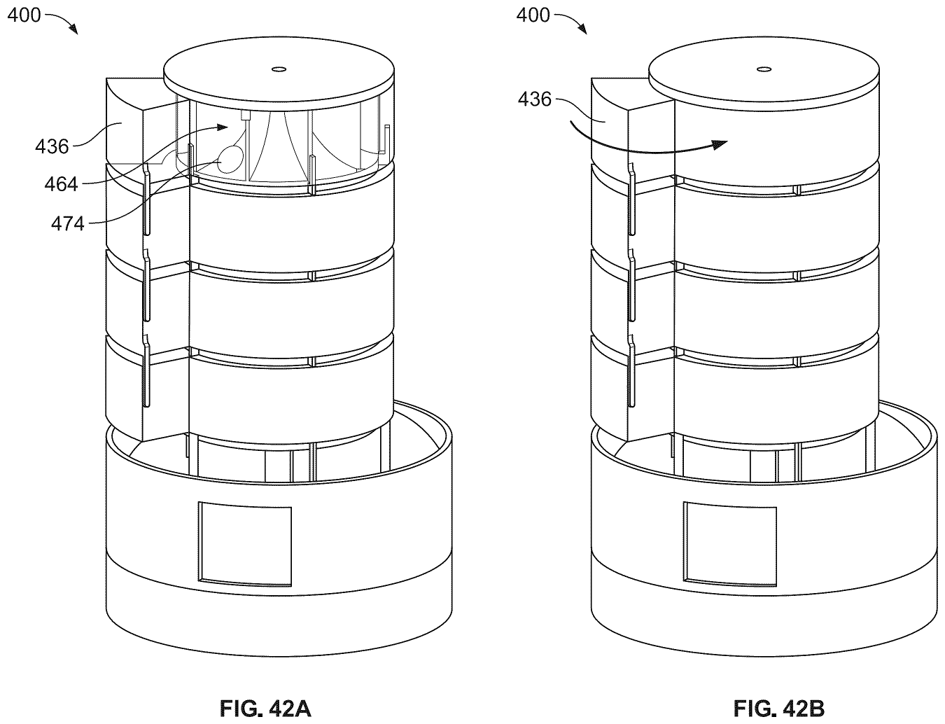

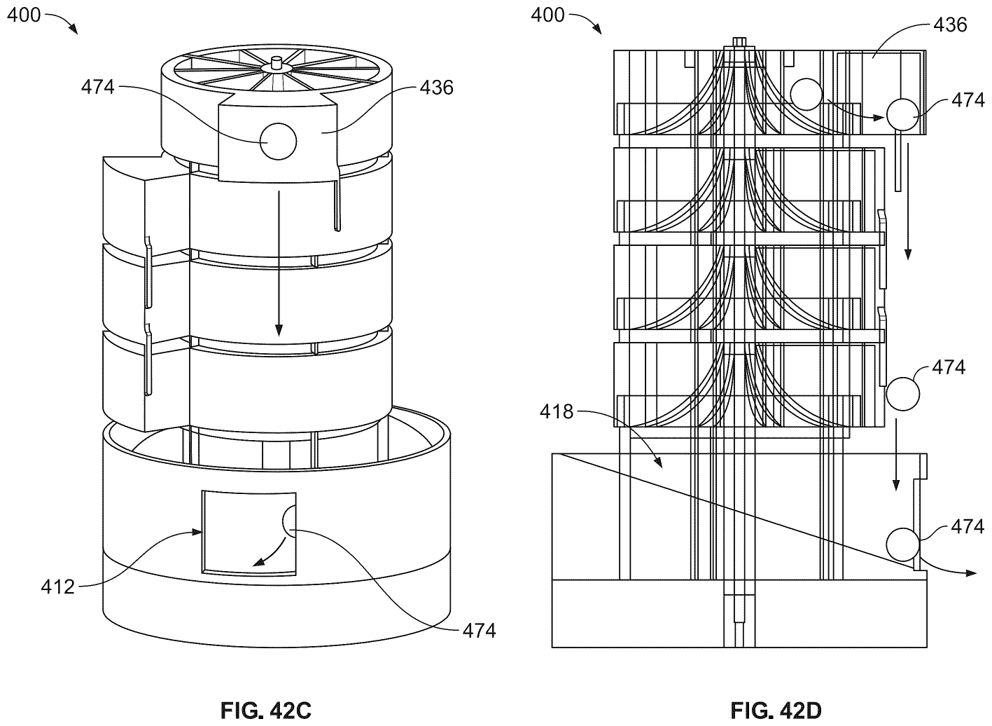

FIGS. 42A-D illustrate rotation of the top-most cartridge cowl 432 and a corresponding dispensing of a pill 474. In FIG. 42A, the dispensing system 400 is in a starting orientation that can correspond to a full dispenser arrangement 410 that has not yet dispensed pills. An exemplary pill 474 is disposed in the compartment 464 adjacent to the dispensing sector 436 of the top-most cartridge cowl 432. As the cartridge cowl 432 rotates in the direction shown (i.e., counterclockwise) in FIG. 42B, the pill 474 is aligned with the dispensing sector 436, as shown in FIG. 42C. The pill 474 can then move from the dispensing sector 436 to the dispensing basin 418. The dispensing basin 418 can include a ramped floor (see FIG. 42D) that is angled downward toward the dispensing opening 412 so that when the pill 474 lands in the dispensing basin 418, it is urged toward the dispensing opening 412 of the housing base 404.

FIG. 42D illustrates another pill 474 moving from the dispensing sector 436 of the top-most sub-cartridge 430 toward the dispensing basin 418. FIG. 42D also shows the relative slopes of each of the ramped surfaces 460 and the ramped floor of the dispensing basin 418. From the perspective of FIG. 42D, as the top-most cartridge cowl 432 continues to turn in the counterclockwise direction, more pills will be dispensed from the compartments of the top-most sub-cartridge 430. Following the dispensing of the top-most sub-cartridge 430, the stop member 438 of the top-most dispensing sector 436 will eventually engage the dispensing sector 436 of the subsequent cartridge cowl 432. When the stop member 438 engages a subsequent dispensing sector 436 (or other portion of the subsequent cartridge cowl 432), the top-most cartridge cowl 432 can cause subsequent cartridge cowls 432 to also rotate in the counterclockwise direction.

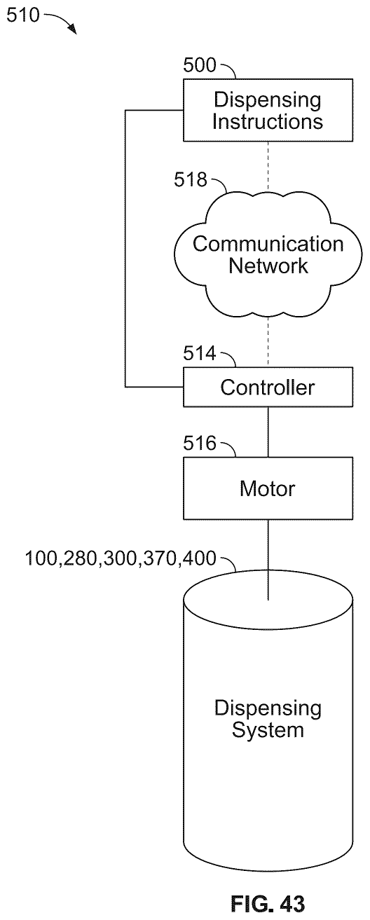

FIG. 43 illustrates an exemplary dispensing method 510 according to an embodiment of the present disclosure. The dispensing method 510 can be used with the dispensing system 100, dispensing system 280, the dispensing system 300, dispensing system 370, the dispensing system 400, or other dispenser systems. One dispensing method can include sending dispensing instructions 500 to a controller 514 that controls the dispensing system 100, 280, 300, 370, 400. The controller 514 can be in communication with a motor 516 or other actuator that drives a movable component of the dispensing system 100, 280, 300, 370, 400, such as the capping disk 386, cap 468, and/or the drive shaft 332, 444, for example.

In some examples, dispensing instructions 500 can be transmitted via a communication network 518, such as a wired or wireless communication network (e.g., Wi-Fi, Bluetooth, radio, etc.). For example, in use, a pharmacist, doctor, or other distributer may load the dispensing system 100, 280, 300, 370, 400 with a treatment plan worth of pills, give the loaded dispensing system to a patient or other recipient, and transmit the dispensing instructions 500 to the dispensing system 100, 280, 300, 370, 400 so that only a prescribed dose of medicine or other dispensable is released from the dispensing system 100, 280, 300, 370, 400 at a desired time. In other examples, the dispensing instructions 500 can be directly programmed into the controller 514 for the dispensing system 100, 280, 300, 370, 400.

The dispensing instructions 500 can provide instructions to the controller 514, which can control the motor 516 to actuate a moving component (e.g., the capping disk 386, cap 468, and/or drive shaft 332, 444) of the dispensing system 100, 280, 300, 370, 400. For example, the motor 316 can be instructed to move the capping disk 386 in a first rotational direction a certain number of degrees. In embodiments where the capping disk 386 includes eight partitions 354c, the motor 516 can move the capping disk in approximately 45-degree increments to dispense one pill at a time. Other rotational increments are possible depending on dosage, size, and number of compartments 370.

As noted herein, the above disclosure references to pills being dispensed from the dispensing systems 100, 280, 300, 370, 400. However, it is contemplated that any type of dispensable item may be dispensed from the dispensing systems 100, 280, 300, 370, 400, e.g., medical dispensables, pills, tablets, projectiles, ammunitions, electronic components, components, food or edible items, fasteners, nuts, bolts, game pieces, securing components, packets, toys, etc. Therefore, the disclosure above is not limited to just dispensing pills.

As noted herein, the dispensing systems 100, 280, 300, 370, 400 disclosed herein are similar to each other. Thus, any description or disclosure of one of the dispensing systems 100, 280, 300, 370, 400 can be use with one or more of the other dispensing systems 100, 280, 300, 370, 400.

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

Unless otherwise specified or limited, the terms “about” and “approximately,” as used herein with respect to a reference value, refer to variations from the reference value of ±15% or less, inclusive of the endpoints of the range. Similarly, the term “substantially,” as used herein with respect to a reference value, refers to variations from the reference value of ±5% or less, inclusive of the endpoints of the range.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein.

Accordingly, for example, configurations of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special-purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

In some implementations, devices or systems disclosed herein can be utilized, manufactured, installed, etc. using methods embodying aspects of the disclosure. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “configured to” indicates that a component, system, or module is particularly adapted for the associated functionality. Thus, for example, a ZZ configured to YY is specifically adapted to YY, as opposed to merely being generally capable of doing so.

Although the presently disclosed technology has been described with reference to preferred examples, workers skilled in the art will recognize that changes may be made in form and detail to the disclosed examples without departing from the spirit and scope of the concepts discussed herein.

1. A dispensing system, the dispensing system comprising:
a dispenser arrangement having a plurality of dividers, each divider of the plurality of dividers comprising:
a base having a first base surface opposite a second base surface;
an array of partitions extending from the second base surface, each partition of the array of partitions defining a leading partition surface and a following partition surface;
a first stop member;
a second stop member, the second stop member of one divider of the plurality of dividers configured to engage the first stop member of another divider of the plurality of dividers to prevent relative movement between the dividers; and
an opening formed in the base and extending through each of the first and second base surfaces.

2. The dispensing system of claim 1, wherein the dispenser arrangement defines a plurality of compartments, and
wherein one compartment of the plurality of compartments is at least partially defined by each of:
the first base surface of a first divider of the plurality of dividers;
the second base surface of a second divider of the plurality of dividers;
the leading partition surface of a first partition of the array of partitions of the second divider; and
the following partition surface of a second partition of the array of partitions of the second divider.

3. The dispensing system of claim 1 further comprising a housing dimensioned to enclose the dispenser arrangement, the housing including a housing base and a housing cover,
wherein the housing cover is configured to be coupled to the housing base.

4. The dispensing system of claim 1, wherein each opening of the plurality of dividers is dimensioned to be aligned in an axial direction to form a dispensing passageway.

5. The dispensing system of claim 4, wherein the leading partition surface is configured to push a pill toward the dispensing passageway so that the pill can pass through at least one of the dividers via the at least one divider's opening.

6. The dispensing system of claim 1, wherein the dispenser arrangement includes a capping disk, the capping disk comprising:
a base having a first base surface opposite a second base surface;
an array of partitions extending from the second base surface of the capping disk; and
a stop member, the stop member configured to engage the first stop member of a divider of the plurality of dividers to prevent relative movement between the divider and the capping disk.

7. The dispensing system of claim 6, wherein the capping disk is in communication with an actuator configured to rotate the capping disk, and
wherein the capping disk is configured to cause one or more dividers of the plurality of dividers to rotate when the stop member of the capping disk engages the first stop member of one of the dividers.

8. The dispensing system of claim 7, wherein the actuator is in communication with a controller, the controller configured to receive dispensing instructions.

9. A dispensing system, the dispensing system comprising:
a dispenser arrangement that defines a rotation axis, the dispenser arrangement comprising:
at least one divider defining a base surface and a dispensing opening extending through the base surface;
a static support coupled to the at least one divider, the static support extending in an axial direction and offset from the rotation axis;
a plurality of sub-cartridges, each sub-cartridge of the plurality of sub-cartridges is separated by the at least one divider, each sub-cartridge of the plurality of sub-cartridge includes partitions that extend radially from a central hub of the sub-cartridge, the central hub includes a keyway or tab configured to engage a corresponding tab or keyway of a drive shaft to rotationally drive the plurality of sub-cartridges; and
a plurality of compartments configured to retain a dispensable item, each of the plurality of compartments is formed by two partitions and the base surface of the at least one divider.

10. The dispensing system of claim 9, wherein the at least one divider includes at least two dividers and the number of dividers is one less than the number of sub-cartridges.

11. The dispensing system of claim 10, wherein the partitions are angularly separated from each other about the rotation axis by a set angle, and the dispensing openings of adjacent dividers are angularly offset from each other about the rotation axis by the set angle.

12. The dispensing system of claim 10, wherein the at least one divider includes radial tabs that engage the static support.

13. The dispensing system of claim 10, further comprising:
a motor;
and a motor controller configured to control the motor based on dispensing instructions.

14. The dispensing system of claim 10, wherein the at least one divider is configured to not rotate.

15. A dispensing system for dispensing dispensable items, comprising:
a housing base having a dispensing basin and a dispensing opening for retrieving a dispensable item; and
a dispenser arrangement, the dispenser arrangement having a plurality of sub-cartridges, each of the plurality of sub-cartridges comprising:
a spacer having a central hub, a ramped surface, and a plurality of partitions extending radially from the central hub; and
a cartridge cowl having a dispensing sector and a track configured to engage a holder of the spacer so that that cartridge cowl is rotatable relative to the spacer,
wherein the plurality of partitions and the ramped surface form a plurality of compartments between each of the plurality of partitions, the plurality of compartments are dimensioned to hold the dispensable items, and
wherein each of the plurality of compartments is dimensioned to dispense the respective dispensable items when the respective dispensing sector is rotationally aligned with the compartment.

16. The dispensing system of claim 15, wherein at least one of the dispensing sectors includes a stop member that extends downward from the at least one dispensing sectors.

17. The dispensing system of claim 16, wherein the stop member is configured to contact the dispensing sector on another sub-cartridge.

18. The dispensing system of claim 15, wherein a bottom of each dispensing sector is open, and
wherein the dispensable items within the plurality of compartments are configured to fall through the bottom of the dispensing sectors.

19. The dispensing system of claim 15, wherein the dispensing basin comprises a ramped floor that funnels to the dispensing opening.

20. The dispensing system of claim 15, wherein the spacers are configured as static disks and do not rotate.
